(19) United States
(12) Patent Application Publication
(10) Pub. No.: US 2026/0219982 A1
(43) Pub. Date: Jul. 30, 2026

(54) Methods and Apparatus for Supporting Interactive Radio Access Network Problem Reporting, Servicing and/or Remediation Using Artificial Intelligence

(71) Applicant: Charter Communications Operating, LLC, St. Louis, MO (US)

(72) Inventor: Pareshkumar Panchal, Highlands Ranch, CO (US)

(21) Appl. No.: 19/038,565

(22) Filed: Jan. 27, 2025

(51) Int. Cl. G06F 11/07

(52) U.S. Cl. CPC G06F 11/0793; G06F 11/0709

(57) ABSTRACT

An interactive system for: i) collecting information regarding communications problems, ii) recommending corrective changes, iii) automatically implementing network changes to address communications problems, iv) confirming that a problem has been resolved due to a change and v) updating a corrective action prediction model based on the corrective results are described. A chatbot in the system is used to interact with a customer reporting a network problem and/or a network engineer working to address one or more network problems. In addition, the chatbot interacts with a network performance recommendation engine (NPRE) which predicts, e.g., using a network correction predication model, a root cause of the reported problem and/or generates a recommendation with regard to a corrective action. Automatic or engineer instructed corrective action is taken by the chatbot AI with success or failure of the change being determined. Corrective action results are used to retrain the corrective action prediction model.

### FIELD

The present invention relates to communications networks and more particularly to methods and/or apparatus for supporting radio access network problem reporting, auto troubleshooting, problem servicing and/or remediation through the use of artificial intelligence.

### BACKGROUND

Significant strides have been made with regard to the use of artificial intelligence (AI) based systems providing access to existing information in response to queries presented in what is sometimes referred to as natural language. Because such systems are capable of carrying on a conversation with a user, they are sometimes referred to as chatbots. Chatbots are AI systems which are normally trained on publicly available information to provide responses to user queries.

Chatbots are finding increasing application in customer service applications where a customer, seeking information or to make a purchase, may interact with a chatbot to obtain the desired information and/or complete a transaction.

While chatbots are gaining increased public acceptance, integrating them into systems which control complex technical systems such as communications networks remains a challenge. This is, in part, due to the fact that limited data is available for training AI systems to address such problems.

While AI systems can be good at identifying patterns and making predictions or recommendations based on a detected pattern, the reliability of such predictions and/or recommendations often depends on having reliable data sets on which to train the models. Unfortunately for communications networks the amount of existing data on known problems and corresponding known solutions, e.g., network changes to be made relating to a given problem, is limited. This presents a problem with regard to how to train an AI system which might be used in a complex technical system such as a communications network. The problem is complicated by the fact that incorrect network changes may result in degraded rather than improved network performance.

Cellular networks often comprise multiple base stations, servers and components with network complexity often being further complicated based on the use of multiple system component vendors and/or technology scenario.

In current communications networks, responding to customers reporting communications network problems, troubleshooting such problems, and making network modifications to address reported problems can be time consuming, taking significant amounts of time in terms of human service hours, e.g., network engineer or technician hours. Resolving reported problems can involve delays in collecting information, identifying the root cause of a problem and taking steps to remediate the problem.

It would be useful if advances in AI systems, e.g., chatbots, could be adapted and/or combined with other network control elements to automate some or all aspects of dealing with customer reported communications network problems.

### SUMMARY

An interactive system for collecting information from network users regarding communications problems, recommending and/or automatically implementing network changes to address communications problems, and/or confirming based on network performance and/or customer feedback that a problem has been resolved is described.

In various embodiments a chatbot AI system is used to interact with a customer reporting a network problem and/or a network technician working to address one or more network problems. In addition, the chatbot AI interacts with a network performance recommendation engine (NPRE) which predicts a root cause of the reported problem and/or generates a recommendation with regard to a corrective action to be taken in response to the reported problem. In some embodiments the NPRE is implemented using artificial intelligence and one or more AI models used to predict the root cause of the problem and/or make a recommendation as to the action to take to correct the problem. The corrective action included in the recommendation includes, in some embodiments, a change in transmit power and/or a change in an antenna configuration and/or orientation, with the change being made at a base station near or covering the area where the problem occurs. This change results, in many cases, in a change in the coverage being provided by the base station in the region where the problem occurs.

The NPRE provides the root cause information and/or the recommendation with regard to a network change to be made to resolve the problem. In response to receiving the root cause information and/or network change recommendation, the chatbot, in some embodiments, automatically implements the recommended network change. In other embodiments the chatbot communicates the information to a network engineer. The network engineer then initiates the recommended change or takes some other corrective action. In some cases, the network engineer can instruct the chatbot to proceed with one or more recommended changes, with the chatbot then implementing the changes instructed to be made by the network engineer. The chatbot can implement the recommended change by instructing or commanding an operations support system (OSS) to implement the change. The OSS then sends the necessary command or signals required to implement the change, e.g., antenna rotation, increase in BS transmit power, change in connected mode parameters for handover, or change in idle mode parameters for cell selection and cell re-selection, at a particular base station, where the recommended change was to be made as indicated by the NPRE or network engineer.

Following making of a network change, the chatbot informs a user, reporting the network problem, that a change was made to the network to address the user's problem and requests the user to test if the change resolved the problem, e.g., by making a call from the UE from which the user reported the problem. After providing the user the opportunity to test if the problem was resolved, the chatbot requests the user to indicate whether the problem was resolved. Based on the user provided feedback the chatbot determines whether or not the problem was resolved.

A customer message database is then updated based on the user feedback whether the problem was resolved or not. In addition, data corresponding to the reported problem and network change is updated to indicate whether the change successfully resolved the problem or not. This data is used as labeled training data with the level indicating whether the particular change corresponding to the specific reported problem was a successful change or unsuccessful change. The chatbot model and/or model used to predict the action to be taken in response to a reported problem is updated based on the reported success or failure of actions taken with regard to the reported problems. Over time, based on user feedback predictions of what actions to be taken based on user complaints is improved based on past experiences and user feedback and/or network performance measurements indicating which actions were successful for particular reported problems and which remedial actions were unsuccessful.

In the case where a remedial action was unsuccessful, e.g., as indicated by a user or as determined based on a decrease rather than increase in network performance, the action can be automatically reversed by the chatbot, and a request for a suggestion of another possible remedial action can be made to the NPRE. In this way a trial and error approach can be used to determine which of a variety of recommended remedial actions actually work with regard to a reported network problem with the results being stored for future model training purposes

As a result of the confirmation of success or failure of various actions to resolve reported problems, reliable training data is collected to improve the training of the AI model used to generate the remedial action recommendation. Since the process can be implemented with little or no engineer input, network performance and customer resolution of communications problems can be solved with the process improving with time as results are used to retrain and improve the model being used to predict the corrective action that should be taken in response to a reported problem.

In addition to providing an interface to a customer, e.g., user, of the communications system, in various embodiments, the chatbot which acts as the customer interface with respect to network problems also serves as an interface through which a network engineer can identify and address network performance problems. This has the advantage of having to implement a single chatbot interface which can be used by both customers and network engineers to address performance problems.

A network engineer can request the chatbot to identify cells with particular types of performance problems. In response the chatbot returns a list of base stations or cells, e.g., a limited number of cells such as 10, which exhibits the worst performance with respect to the problem identified by the network engineer. The chatbot then requests root cause analysis and recommended corrective action for a base station on the list from the NPRE. The NPRE, in some embodiments, uses a corrective action prediction model to determine one or more recommended corrective actions, e.g., one or more network changes likely to correct the performance problem associated with the base station, for which the corrective action is being recommended. The chatbot is provided the recommended corrective action information, and then the chatbot presents the recommended corrective action information to the network engineer. The network engineer instructs, e.g., commands, the chatbot to implement one of the recommended corrective actions. Network performance is monitored and reported to the network engineer, allowing the engineer to make a decision as to whether to retain or rollback the corrective action. A decision to rollback the corrective action by the network engineer is interpreted as a failure of the corrective network action that was implemented to correct the performance problem the network engineer inquired about, while retention of the corrective action by the network engineer is interpreted as a successful corrective action which addresses the network performance problem the network engineer inquired about.

The corrective action prediction model is updated with regard to the network performance problem addressed by the network engineer, with the network corrective action being labeled as successful or unsuccessful during the model update/retraining process based on whether the network engineer retained or rolled back the network corrective action.

Since the same corrective action prediction model is updated based on changes made in response to customer complaints and/or network engineer attempts to address network problems, overall corrective action prediction success, e.g., recommendations for network changes, is likely to improve as the retraining is based on actual success or failure of network changes to resolve previously detected or encountered problems. This is because unsuccessful changes will be less likely to be recommended for the same or similar problems due to model retraining, while successful network change actions in response to encountered problems will become more likely to be recommended due to the retraining of the corrective action prediction model being used to make network changes recommendations.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing of an exemplary communications system in accordance with an exemplary embodiment.

FIG. 2 is a drawing of a map showing: roads, the locations of base stations, and the location of each of the UEs.

FIG. 3 is a drawing of a map showing: roads, the locations of base stations, corresponding cell coverage areas for each of the base stations and the locations of UEs, wherein base stations in the system have different size coverage areas and/or correspond to different antenna directions.

FIG. 4 illustrates an example of live network issue troubleshooting, of a problem reported by a customer to a chatbot, and a response in accordance with an exemplary embodiment of the present invention.

FIG. 5A illustrates a first part of an example of support of network engineer (NE) review of network conditions, e.g., real or near real time conditions, by accessing radio network analyzer using a chatbot interface, in accordance with an exemplary embodiment.

FIG. 5B illustrates a second part of an example of support of network engineer (NE) review of network conditions, e.g., real or near real time conditions, by accessing radio network analyzer using a chatbot interface, in accordance with an exemplary embodiment.

FIG. 5 illustrates that FIG. 5A and FIG. 5B are combined to form FIG. 5.

FIG. 6A is a first part of a signaling diagram illustrating an exemplary method of operating a communications system including a chatbot and a network performance recommendation engine (NPRE) to perform troubleshooting of a problem reported by a customer, identify potential corrective actions and implement corrective actions, in accordance with an exemplary embodiment.

FIG. 6B is a second part of a signaling diagram illustrating an exemplary method of operating a communications system including a chatbot and a network performance recommendation engine (NPRE) to perform troubleshooting of a problem reported by a customer, identify potential corrective actions and implement corrective actions, in accordance with an exemplary embodiment.

FIG. 6C is a third part of a signaling diagram illustrating an exemplary method of operating a communications system including a chatbot and a network performance recommendation engine (NPRE) to perform troubleshooting of a problem reported by a customer, identify potential corrective actions and implement corrective actions, in accordance with an exemplary embodiment. FIG. 6A is a first part of a signaling diagram illustrating an exemplary method of operating a communications system including a chatbot and a network performance recommendation engine (NPRE) to perform troubleshooting of a problem reported by a customer, identify potential corrective actions and implement corrective actions, in accordance with an exemplary embodiment.

FIG. 6D is a fourth part of a signaling diagram illustrating an exemplary method of operating a communications system including a chatbot and a network performance recommendation engine (NPRE) to perform troubleshooting of a problem reported by a customer, identify potential corrective actions and implement corrective actions, in accordance with an exemplary embodiment.

FIG. 6E is a fifth part of a signaling diagram illustrating an exemplary method of operating a communications system including a chatbot and a network performance recommendation engine (NPRE) to perform troubleshooting of a problem reported by a customer, identify potential corrective actions and implement corrective actions, in accordance with an exemplary embodiment.

FIG. 6F is a sixth part of a signaling diagram illustrating an exemplary method of operating a communications system including a chatbot and a network performance recommendation engine (NPRE) to perform troubleshooting of a problem reported by a customer, identify potential corrective actions and implement corrective actions, in accordance with an exemplary embodiment.

FIG. 6 illustrates that FIG. 6A, FIG. 6B, FIG. 6C, FIG. 6D, FIG. 6E and FIG. 6F are combined to form FIG. 6.

FIG. 7A is a first part of signaling diagram illustrating an exemplary method of operating a communications system, including a chatbot and a network performance recommendation engine (NPRE), to perform support to a network engineer (NE) reviewing of network conditions, e.g., real or near real time conditions, said support including identifying cells with poor performance, performing root cause analysis and providing possible corrective actions, in accordance with an exemplary embodiment.

FIG. 7B is a second part of signaling diagram illustrating an exemplary method of operating a communications system, including a chatbot and a network performance recommendation engine (NPRE), to perform support to a network engineer (NE) reviewing of network conditions, e.g., real or near real time conditions, said support including identifying cells with poor performance, performing root cause analysis and providing possible corrective actions, in accordance with an exemplary embodiment.

FIG. 7C is a third part of signaling diagram illustrating an exemplary method of operating a communications system, including a chatbot and a network performance recommendation engine (NPRE), to perform support to a network engineer (NE) reviewing of network conditions, e.g., real or near real time conditions, said support including identifying cells with poor performance, performing root cause analysis and providing possible corrective actions, in accordance with an exemplary embodiment.

FIG. 7D is a fourth part of signaling diagram illustrating an exemplary method of operating a communications system, including a chatbot and a network performance recommendation engine (NPRE), to perform support to a network engineer (NE) reviewing of network conditions, e.g., real or near real time conditions, said support including identifying cells with poor performance, performing root cause analysis and providing possible corrective actions, in accordance with an exemplary embodiment.

FIG. 7E is a fifth part of signaling diagram illustrating an exemplary method of operating a communications system, including a chatbot and a network performance recommendation engine (NPRE), to perform support to a network engineer (NE) reviewing of network conditions, e.g., real or near real time conditions, said support including identifying cells with poor performance, performing root cause analysis and providing possible corrective actions, in accordance with an exemplary embodiment.

FIG. 7F is a sixth part of signaling diagram illustrating an exemplary method of operating a communications system, including a chatbot and a network performance recommendation engine (NPRE), to perform support to a network engineer (NE) reviewing of network conditions, e.g., real or near real time conditions, said support including identifying cells with poor performance, performing root cause analysis and providing possible corrective actions, in accordance with an exemplary embodiment.

FIG. 7G is a seventh part of signaling diagram illustrating an exemplary method of operating a communications system, including a chatbot and a network performance recommendation engine (NPRE), to perform support to a network engineer (NE) reviewing of network conditions, e.g., real or near real time conditions, said support including identifying cells with poor performance, performing root cause analysis and providing possible corrective actions, in accordance with an exemplary embodiment.

FIG. 7 illustrates that FIG. 7A, FIG. 7B, FIG. 7C, FIG. 7D, FIG. 7E, FIG. 7F and FIG. 7G are combined to form FIG. 7.

FIG. 8 illustrates an exemplary interactive network and configuration controller (INACC) which can be used as the INACC of the system shown in FIG. 1.

FIG. 9 illustrates an exemplary set of corrective action predication model training data that can be used in the INACC shown in FIG. 8 and updated over time based on the success or failure of network changes made to address network problems and/or network performance issues.

### DETAILED DESCRIPTION

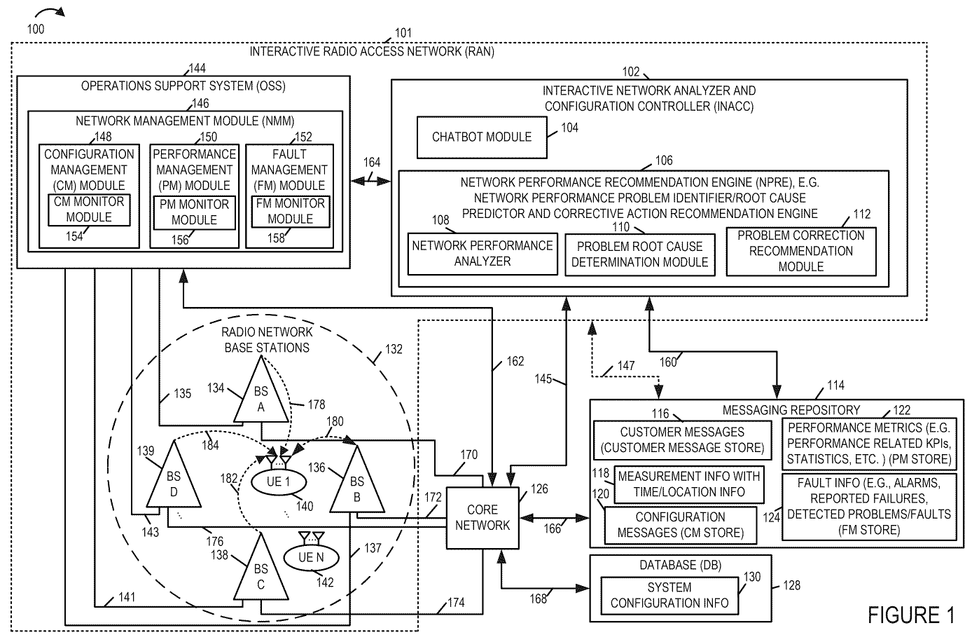

FIG. 1 is a drawing of an exemplary communications system 100 in accordance with an exemplary embodiment. Exemplary communications system 100 includes an interactive network analyzer and configuration controller (INACC) 102, a messaging repository 114, a core network 126, a database (DB) 128, a set 132 of radio network base stations, and an operations support system (OSS) 144 coupled together as shown. In some embodiments, the INACC 102. OSS 144 and set 132 of radio network base stations are part of an Interactive Radio Access Network (RAN).

The interactive network analyzer and configuration controller (INACC) 102 includes a chatbot module 104 and a network performance recommendation engine (NPRE), e.g., a network performance problem identifier/root cause predicator and corrective active recommendation engine. The NPRE includes a network performance analyzer 108, a problem root cause determination module 110 and a problem correction recommendation module 112. In some embodiments, the chatbot module 104 and the network performance recommendation engine (NPRE) 106 are located within different entities in the communications system; however, the chatbot 104 and the NPRE interact, e.g., communicate, with one another.

The messaging repository 114 includes customer messages 116, e.g., a customer message store, measurement information, e.g., measurement reports from base stations and/or UEs, with time/location information 118, configuration messages 120, e.g., a CM store, and performance metrics 122, e.g., performance related key performance indicators (KPIs), e.g., a PM store, and fault information 124, e.g., alarms, reported failures, and detected problems/faults, e.g., a FM store.

Database 128 includes system configuration information 130, e.g., including settings, e.g., including transmission power level information and antenna information, e.g., antenna direction settings, for each base stations in the set 132 of radio network base stations.

Core network 126, e.g., a 5GC, includes, e.g., a plurality of core network nodes implementing a plurality of core network functions, e.g. an access and mobility management function (AMF), a session management function (SMF), a user plane function (UPF), a policy control function (PCF), a unified data management (UDM), a unified data repository (UDR), etc.

Set 132 of radio network base stations includes a plurality of base stations including base station A 132, base station B 136, base station C 138, and base station D 139. Different base stations in the set 132 of base stations may, and sometimes do, have different transmission power levels, different coverage ranges, and/or different antenna directivity, e.g., in accordance with the network configuration settings.

Operations support system (OSS) 144 includes a network management module (NMM) 146. The network management module (NMM) 146 includes a configuration management (CM) module 148, a performance management (PM) module 150 and a fault management (FM) module 152. The configuration management (CM) module 148 includes a CM monitor module 154. The performance management (PM) module 150 includes a PM monitor module 156. The fault management (FM) module 152 includes a FM monitor module 158.

INACC 102 is coupled to OSS 144 via communications link 164. INACC 102 is coupled to messaging repository 114 via communications link 160. Messaging repository 114 is coupled to core network 126 via communications link 166. Core network 126 is coupled to database 128 via communications link 168. Core network 126 is coupled to OSS 144 via communications link 162. Core network 125 is coupled to INACC 102 via communications link 145. Core network 126 is coupled to the base stations (BS A 134, BS B 136, BS C 138, . . . , BS D 139) via communications link (170, 172, 174, . . . , 176), respectively. OSS 144 is coupled to the base stations (BS A 134, BS B 136, BS C 138, . . . , BS D 139) via communications link (135, 137, 141, . . . , 143), respectively. Bi-directional arrow 147 indicates that messaging repository 114 may be coupled to any of the elements within interactive RAN 101.

Exemplary communications system 100 further includes a plurality of user equipments (UEs) (UE 1 140, . . . , UE N 142). At least some of the UEs are mobile UEs may move through the system 100 and be connected to different base stations at different times. UE 1 140 is, e.g., a customer device. UE N 142 is, e.g., a network engineer (NE) device. In this particular example, UE 1 140 is shown receiving wireless signals from each of the BSs (BS A 134, BS B 136, BS C 138, . . . , BS D 139); and, in addition, UE 1 140 is communicating uplink signals to BS B 136.

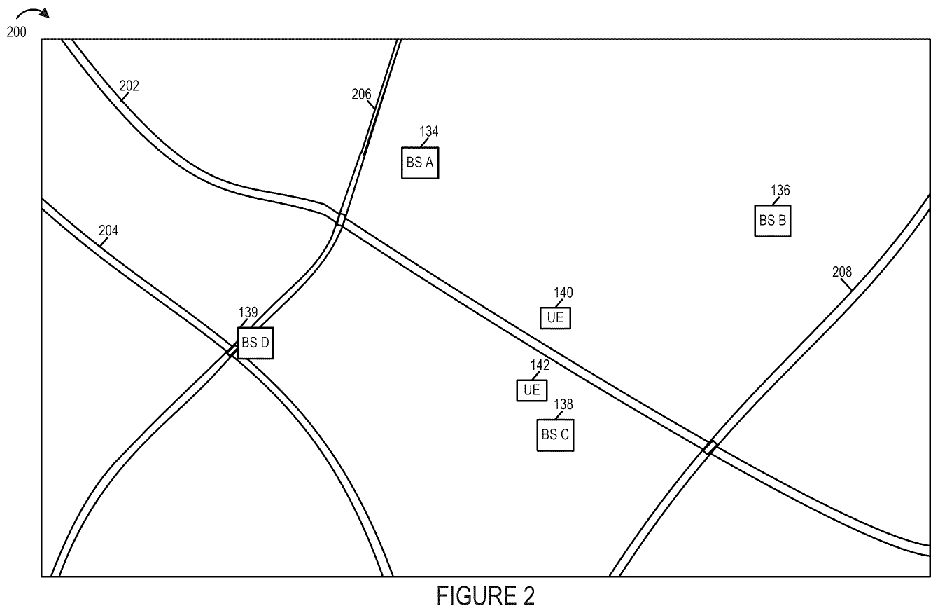

FIG. 2 is a drawing of an exemplary map 200 showing: roads (202, 204, 206, 208), the location of each of the base stations (BS A 134, BS B 136, BS C 138, BS D 139), and the location of each of the UEs (UE 1 140, UE N 142).

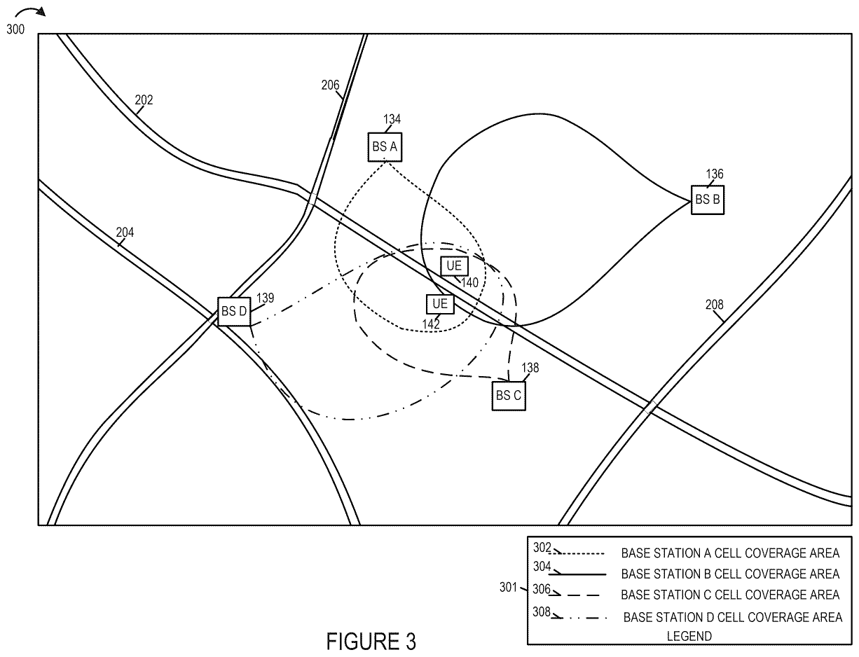

FIG. 3 is a drawing of an exemplary map 300 and a corresponding legend 301. Map 300 shows: roads (202, 204, 206, 208), the location of each of the base stations (BS A 134, BS B 136, BS C 138, BS D 139), corresponding wireless coverage areas for each of the base stations (BS A 134, BS B 136, BS C 138, BS D 139), and the location of each of the UEs (UE 1 140, UE N 142). Legend 301 indicates: i) dotted lines 302 are used to represent the BS A cellular coverage area; ii) solid lines 304 are used to represent the BS B cellular coverage area; dashed lines 306 are used to represent the BS C cellular coverage area; and dot/dash lines 308 are used to represent the BS D cellular coverage area.

In various messaging flows, the core network 126 will interact with chatbot 104 if the issue is with core 126 otherwise it will be managed at RAN level

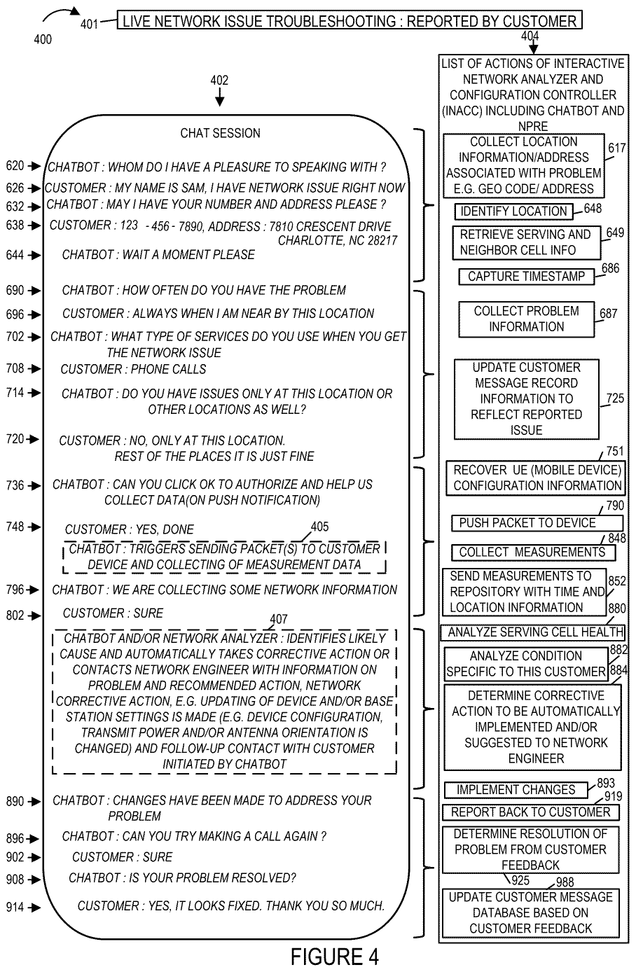

FIG. 4 illustrates an example of live network issue troubleshooting of a problem reported by a customer to a chatbot and a response in accordance with an exemplary embodiment of the present invention, as indicated by title box 401. FIG. 4 includes an exemplary chat session 402 between a chatbot and a customer and a list 404 of actions performed by an interactive network analyzer and configuration controller (INACC) including a chatbot and a network performance recommendation engine (NPRE), in accordance with an exemplary embodiment. The customer is, e.g., the user of UE 1 140, of system 100 of FIG. 1; the chatbot is, e.g., chatbot 104 of system 100 of FIG. 1; the INACC is, e.g., INACC 102 of system 100 of FIG. 1; and the NPRE is, e.g. NPRE 106 of FIG. 1.

The chatbot sends message 602, which communicates “Whom do I have the pleasure to be speaking with?”, to the customer. The customer responds with message 626, which communicates “My name is Sam. I have a network issue right now.” to the chatbot.

In step 617, the chatbot is operated to collect location information/address associated with the problem, e.g., a geo code and/or address. The chatbot sends message 622, which communicates “May I have your number and address please?”, to the customer. The customer responds with message 638, which communicates “123-456-7890, address: 7810 Crescent Drive Charlotte, NC 28217” to the chatbot. The chatbot responds with message 644, which communicates “Wait a moment please.”

In step 648 the chatbot identifies the location, and in step 649 the chatbot retrieves serving and neighbor cell information. In step 686, the chatbot captures a timestamp, e.g., a reporting time timestamp.

In step 687, the chatbot is operated to collect problem information. The chatbot sends message 690, which communicates “How often do you have the problem?” to the customer. The customer responds with message 696, which communicates “Always when I am near this location.” The chatbot sends follow-up message 702, which communicates “What type of services do you use when you get the network issue?” to the customer. The customer responds with message 708, which communicates “phone calls”. The chatbot sends follow-up message 702, which communicates “Do you have issues only at this location or at other locations as well?” to the customer. The customer responds with message 720, which communicates “No, the problem is only at this location. At the rest of the places it is just fine.” In step 725, the chatbot is operated to update the customer message record information to reflect the reported issue.

The chatbot sends message 736, which communicates “Can you click OK to authorize and help us collect data (on push notification)?”. The customer responds by clicking OK and sends message “Yes, done” to the chatbot. This acceptance triggers sending packet(s) to the customer device and collecting of measurement data, as indicated by information block 405.

In step 751 the chatbot recovers UE (mobile device operated by customer) configuration information. In step 790 the chatbot is operated to push packet(s) to the UE device operated by the customer. In step 848 the chatbot is operated to collect measurements. The chatbot sends message 796, which communicates “We are collecting some network information.” To the customer. The customer responds with message 802, which communicates “sure”. In step 852 the chatbot is operated to send measurements to the repository with time and location information.

The chatbot and/or network analyzer identifies a likely cause and automatically takes corrective action or contacts a network engineer (NE) with information on the problem and a recommended action, network corrective action, e.g., updated of device and/or base station setting is made, e.g., device configuration transmit power and/or antenna orientation is changed) and follows up contact with customer initiated by chatbot, as indicated in information box 407. In step 880 the network performance recommendation engine (NPRE) of the INACC analyzes the serving cell health. In step 882, the NPRE analyzes the condition specific to this customer. In step 884 the NPRE determines a corrective action to be automatically implemented and/or suggested to a network engineer. In step 893 the chatbot is operated to implement changes, e.g., in accordance with the recommendation from the NPRE.

In step 919 the chatbot is operated to report back to the customer. The chatbot sends message 890, which communicates “Changes have been made to address your problem” to the customer.

In step 925 the chatbot is operated to determine if the problem has been resolved from customer feedback. The chatbot sends message 896, which communicates “Can you try making a call again?” to the customer. The customer responds with message 906, which communicates “sure”. The customer makes a call, which in this example is successful, e.g., no network issue.

The chatbot queries the customer with message 908, which communicates “Is your problem resolved.” The customer responds with message 914, which communicates “Yes, it looks fixed. Thank you so much.” In this example, the determination is that the problem was successfully resolved.

In step 988 the chatbot updates the customer message database based on the customer feedback.

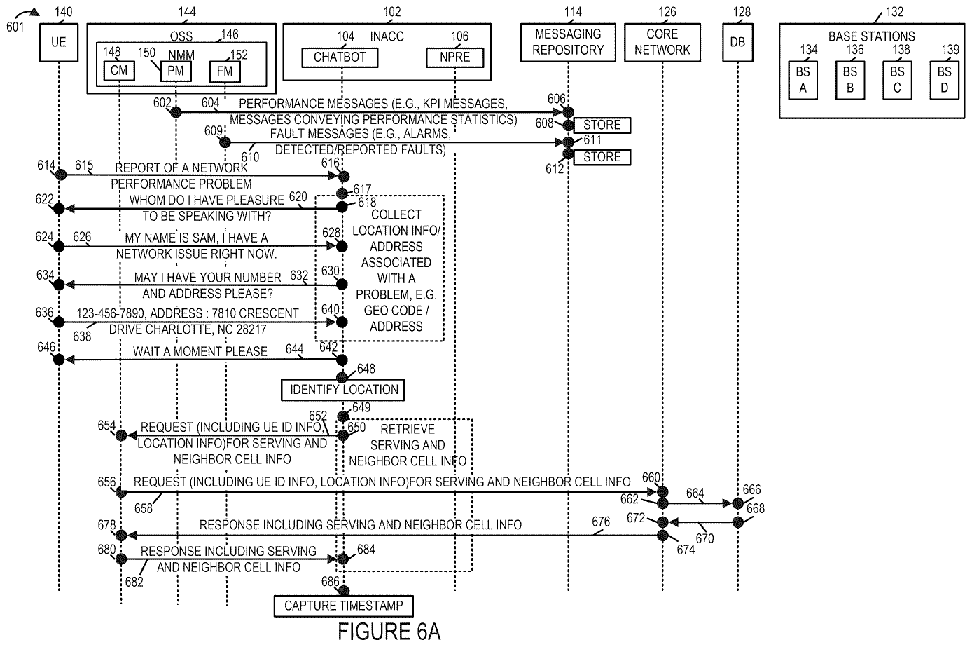

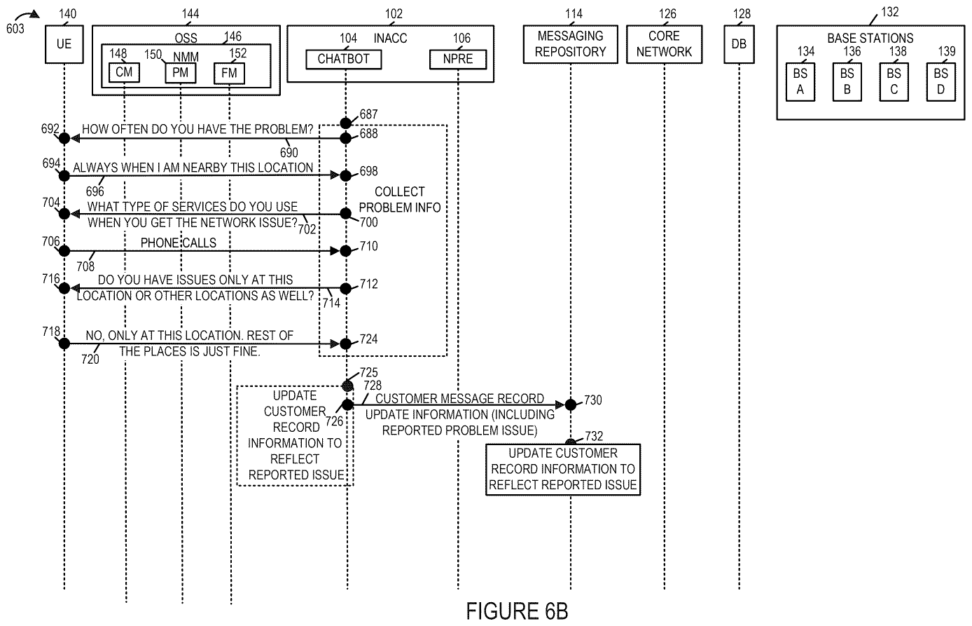

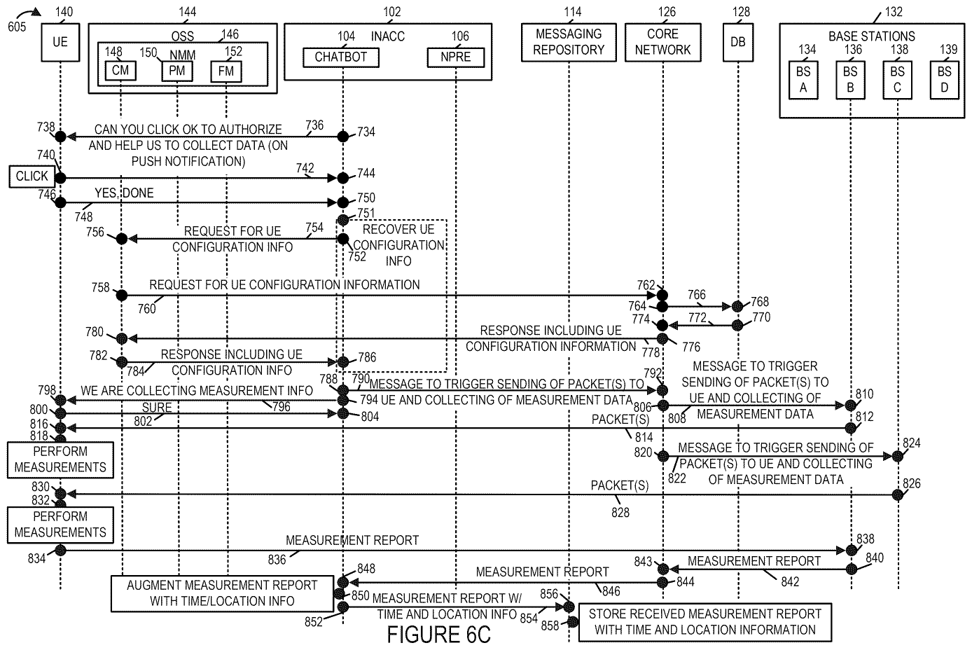

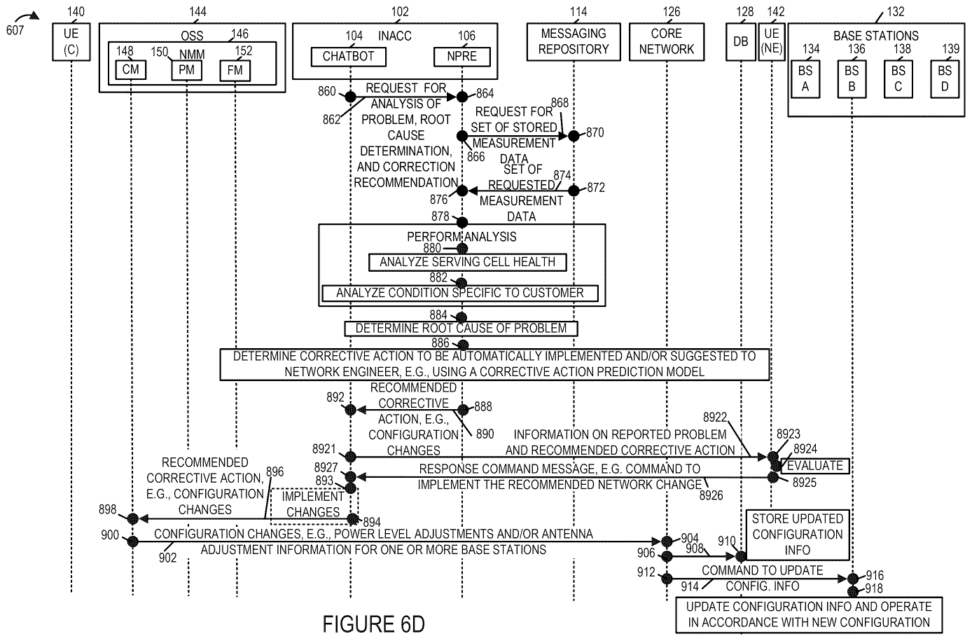

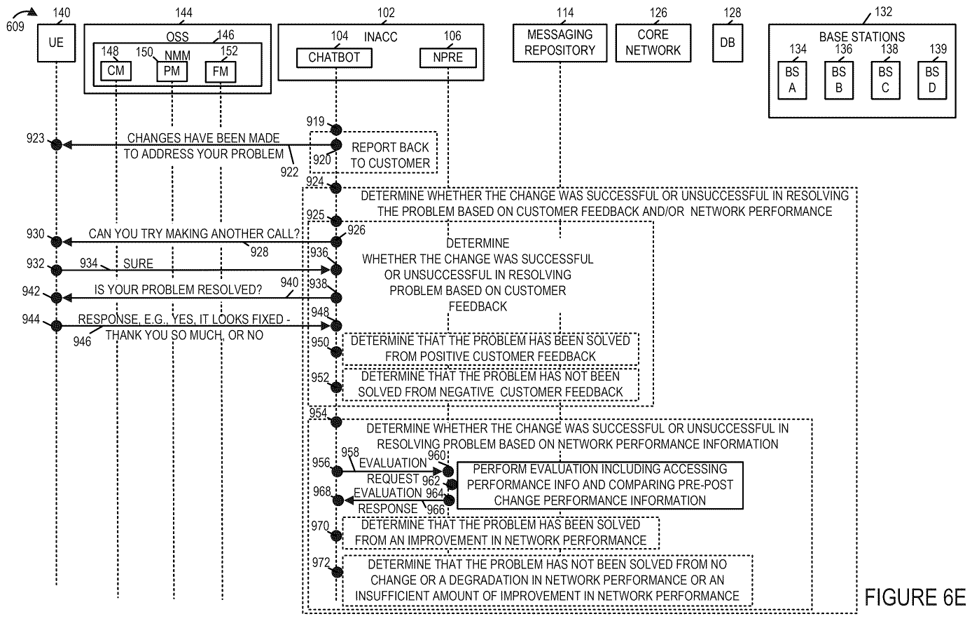

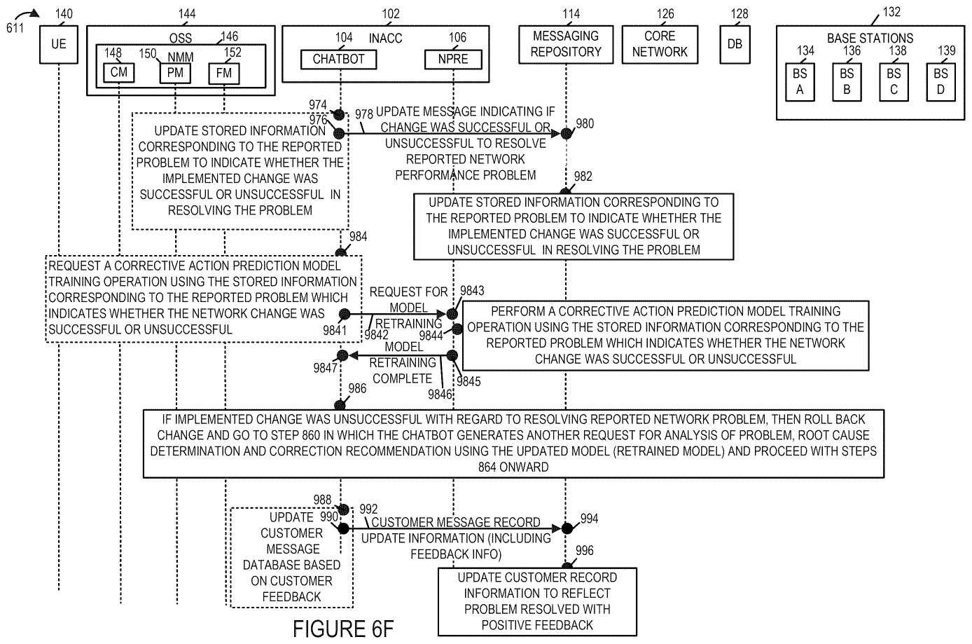

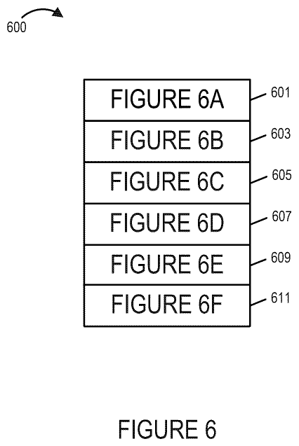

Signaling diagram 600 of FIG. 6 illustrates a more detailed representation corresponding to the example of FIG. 4, which further includes exemplary signaling and operations performed by additional elements in the communications system, as part of the troubleshooting and resolution process.

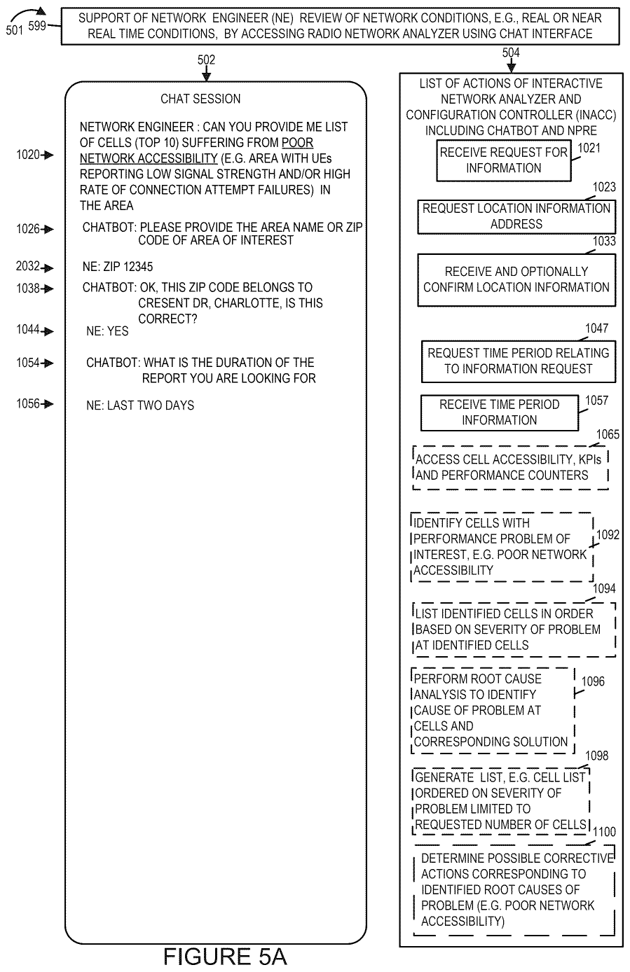

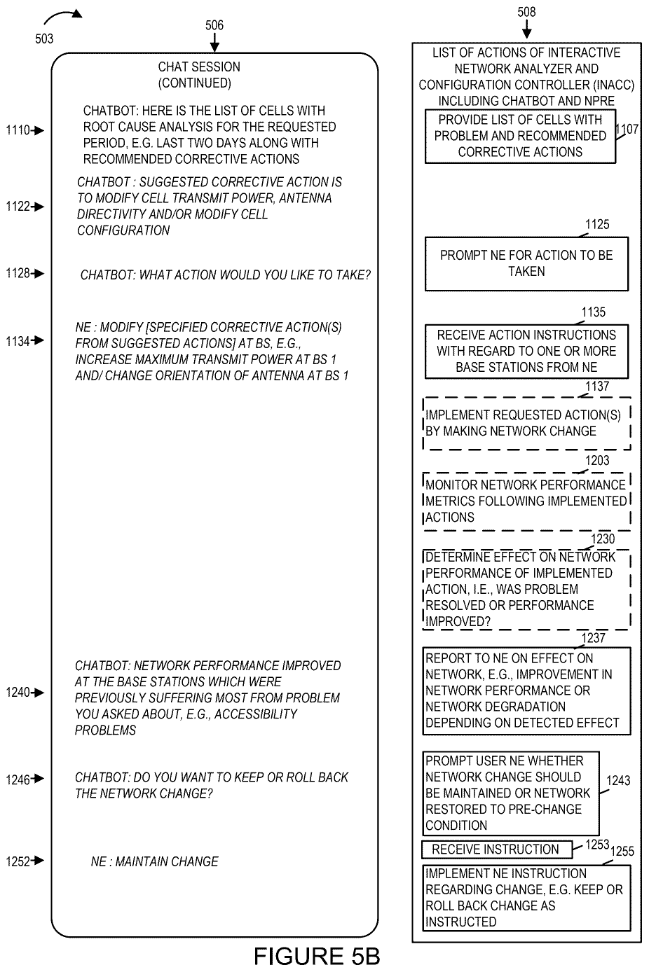

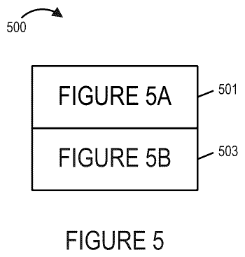

FIG. 5 is a drawing 500, comprising the combination of Part A 501 of FIG. 5A and Part B 503 of FIG. 5B, which illustrates an example of support of a network engineer (NE) review of condition, e.g., real or near real time conditions, by accessing a radio network analyzer using a chat interface in accordance with an exemplary embodiment of the present invention, as indicated by title box 599. FIG. 4 includes an exemplary chat session 502 between a chatbot and a network engineer (NE) and a list 504 of actions performed by an interactive network analyzer and configuration controller (INACC) including a chatbot and a network performance recommendation engine (NPRE), in accordance with an exemplary embodiment. The network engineer (NE) is, e.g., the user of UE N 142, of system 100 of FIG. 1; the chatbot is, e.g., chatbot 104 of system 100 of FIG. 1; the INACC is, e.g., INACC 102 of system 100 of FIG. 1; and the NPRE is, e.g. NPRE 106 of FIG. 1.

Referring to FIG. 5A, the network engineer sends message 1020, which communicates “Can you provide me with a list of cells (top 10) suppering from poor network accessibility (e.g., area with UEs reporting low signal strength and/or a high rate of connection attempt failures) in the area?” to the chatbot. In step 1021, the chatbot receives the request for information. In step 1023 the chatbot requests a location information address. Chatbot sends message 1026, which communicates “Please provide the area name or zip code of the area of interest.” The network engineer responds and sends message 2032, which communicates “Zip 12345”. In step 1033, the chatbot receives and optionally confirms the location. As part of the optional confirmation process, the chatbot sends message 1038, which communicates “Ok, this zip code belongs to Cresent Drive, Charlotte, North Carolina. Is this correct?” to the network engineer. The network engineer responds and sends message 1044, which communicates “Yes” to the chatbot. In step 1047, the chatbot request the time period relating to the request. The chatbot sends message 1054, which communicates “What is the duration of the report you are looking for?” to the network engineer. The network engineer responds and sends message 1056, which communicates “Last two days” to the chatbot. In step 1057 the chatbot receives the time period information,

In step 1065 the NPRE accesses cell accessibility, KPIs and performance counters. In step 1092 the NPRE identifies cells with the performance problem of interest, e.g., poor network accessibility. In step 1094 the NPRE lists identified cells in order based on the severity of the problem at the identified cells. In step 1096 the NPRE performs a root cause analysis to the cause of the problem at the cells and corresponding solution. In step 1098 the NPR generates a list, e.g., a cell list ordered on severity of the problem, said generated list being limited to the requested number of cell, e.g., 10. In step 1098 the NPRE determines possible corrective actions to be taken corresponding to the identified root causes of the problem (e.g., poor network accessibility).

Referring to FIG. 5B, in step 1107, the chatbot provides the list of cells with the problem and recommended corrective action. The chatbot sends message 1110, which communicates “Here is a list of cells with root cause analysis for the requested period, e.g., last tow days, along with recommended corrective actions.” to the network engineer. The chatbot also sends message 1122, which communicates “suggested corrective action is to modify cell transmit power, antenna directivity, and/or modify cell configuration.” to the network engineer.

In step 1125 the chatbot prompts the network engineer for action to be taken. The chatbot sends message 1128, which communicates “What action would you like to take?” to the network engineer. The network engineer responds and sends message 1134, which communicates “Modify [specified corrective action(s) from suggested action] at base station, e.g., increase maximum transmit power at BS 1 and/or change orientation of antenna at BS 1” to the chatbot.

In step 1135 the chatbot receives action instructions with regard to one or base stations from the network engineer. In step 1137 the chatbot implements the requested action(s) by making a network change. In step 1203 the chatbot monitors network performance metrics following implemented actions. In step 1230 the NPRE evaluates the effect of change, e.g., based on comparison or pre-change performance information to post-change performance information, e.g., determines the effect on network performance of the implemented action, i.e., was the problem resolved or was performance improved. In step 1237 the chatbot reports to the network engineer on the effect on the network, e.g., improvement in network performance or network degradation, depending on the detected effect. For example, the chatbot sends message 1240, which communicates “Network performance improved at the base station which were previously suffering most from the problem you asked about, e.g., accessibility problems” to the network engineer. In step 1243, the chatbot prompts the user network engineer whether the network should change should be maintained or whether the network should be restored to pre-change condition. Thus, chatbot sends message 1246, which communicates “Do you want to keep or rollback the network change?” to the network engineer. The network engineer responds and sends message 1252, which communicates “Maintain change” to the chatbot. In step 1253 the chatbot receives the instruction of message 1252. In step 1255 the chatbot implements the received network engineer instruction regarding the change, e.g., keep or roll back as instructed.

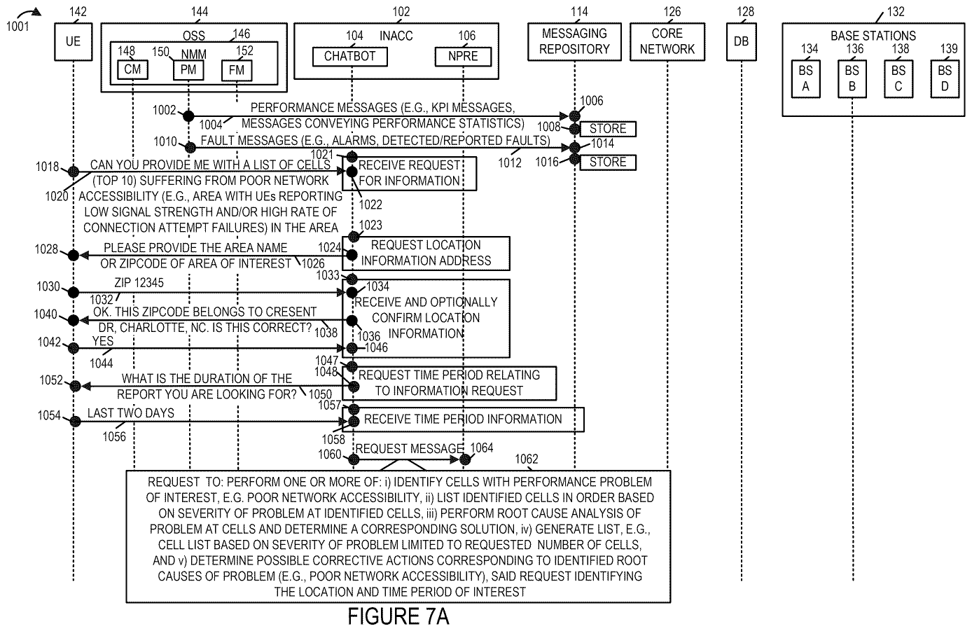

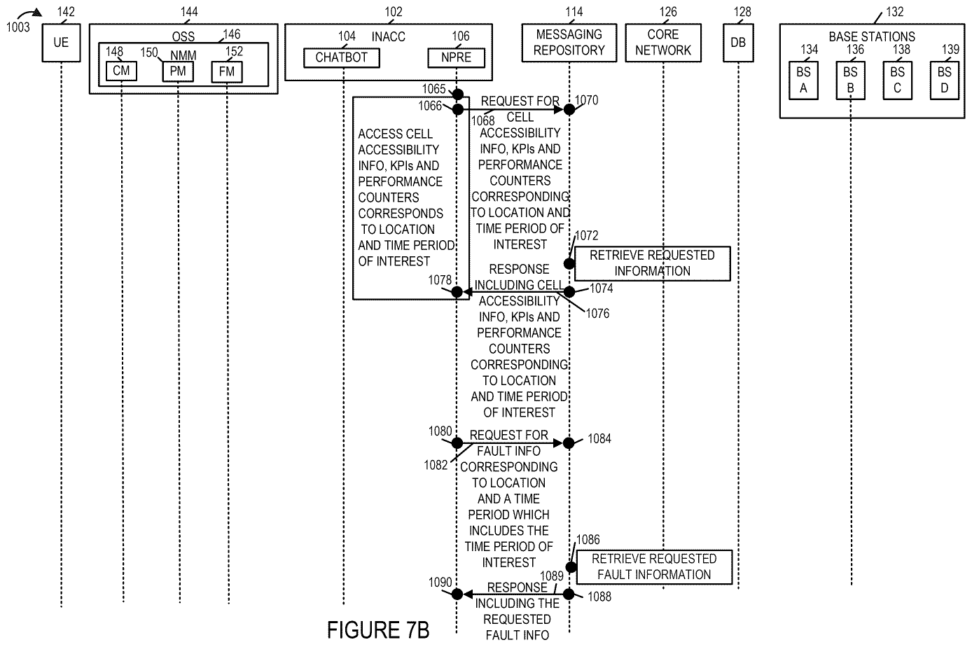

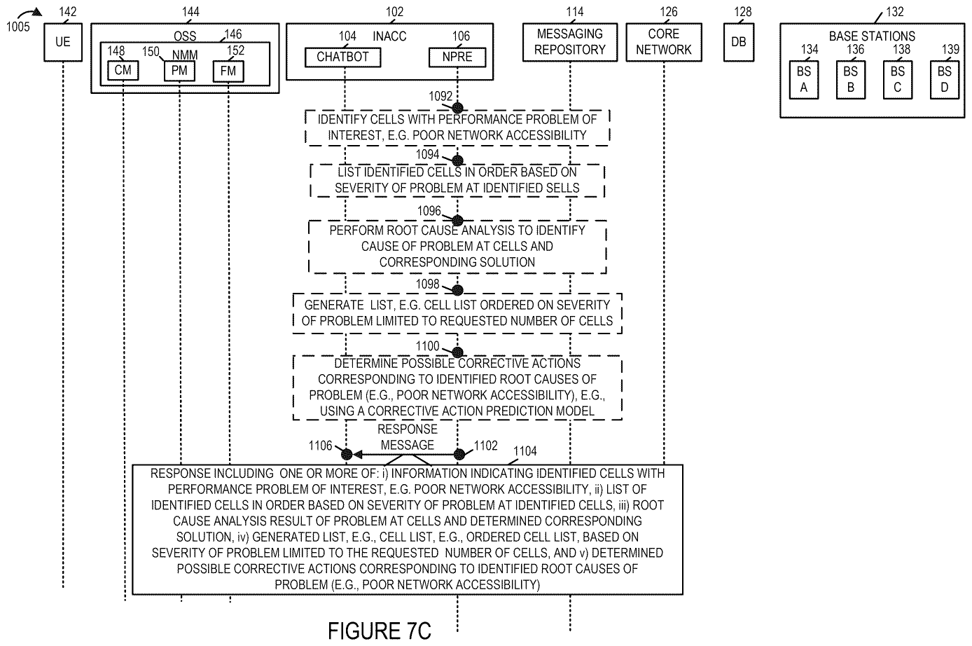

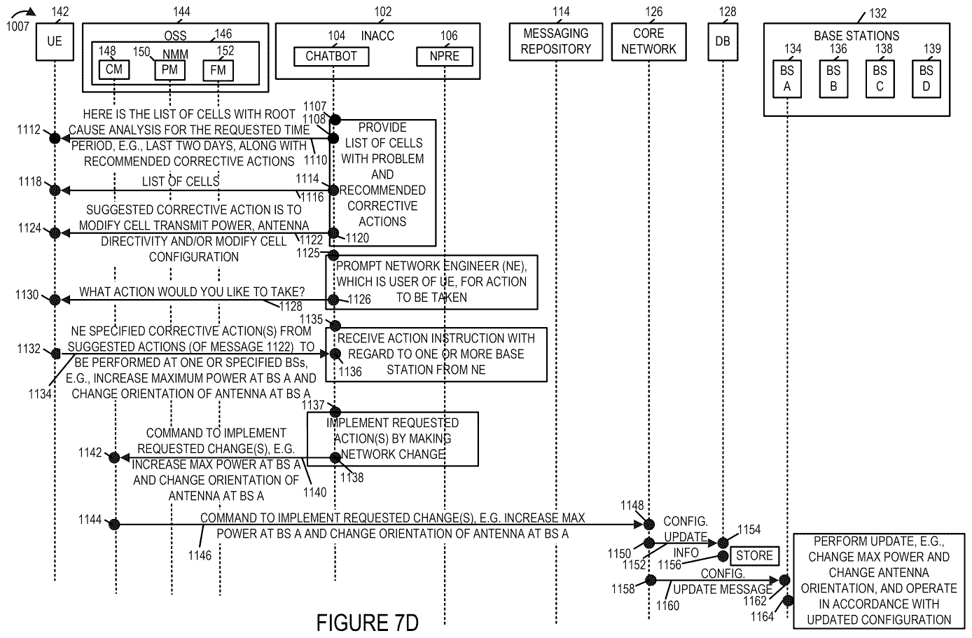

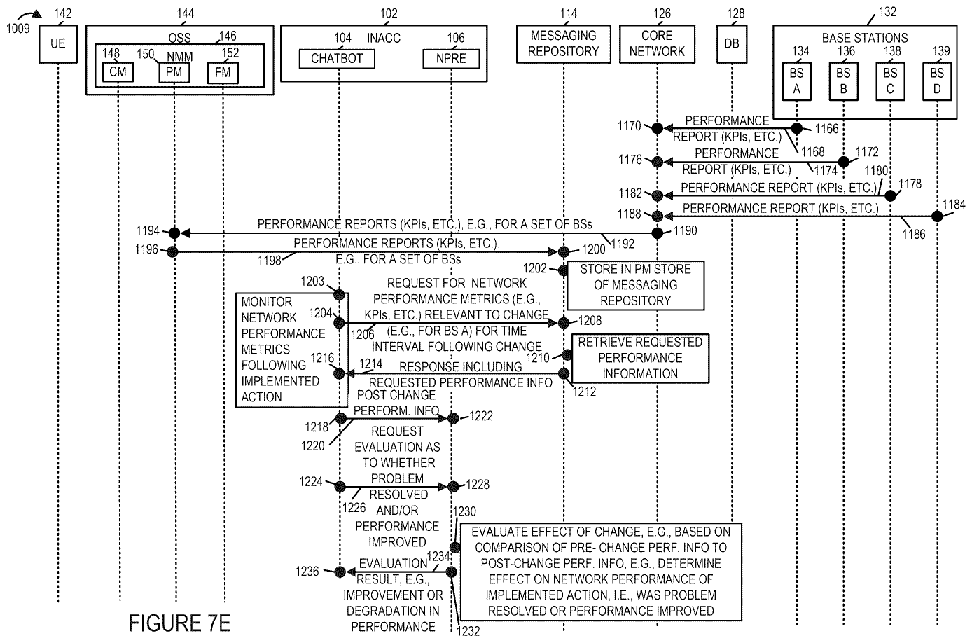

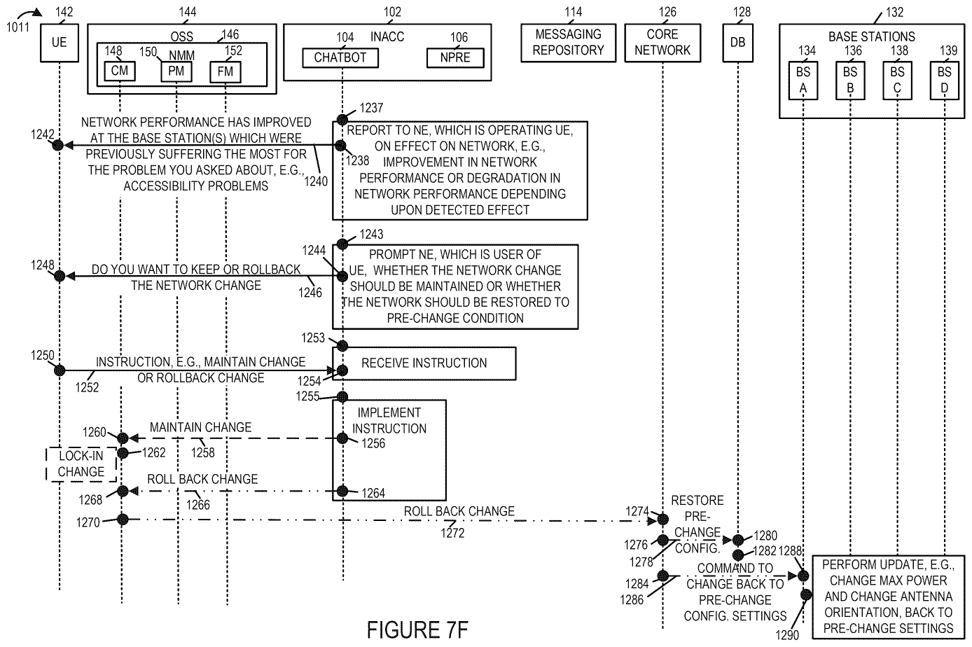

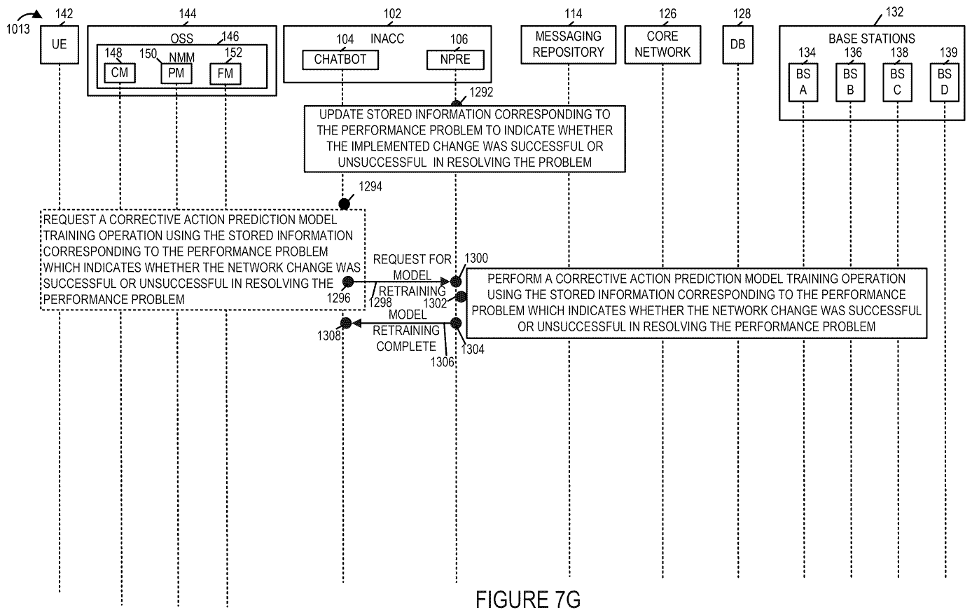

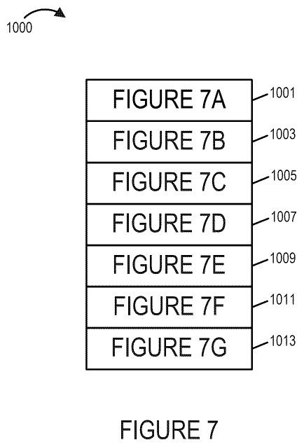

Signaling diagram 1000 of FIG. 7 illustrates a more detailed representation corresponding to the example of FIG. 5, which further includes exemplary signaling and operations performed by additional elements in the communications system, as part of the support to the network engineer, e.g., in a network conditions review, problem identification, and network change process.

FIG. 6, comprising the combination of FIG. 6A, FIG. 6B, FIG. 6C, FIG. 6D, FIG. 6E and FIG. 6F, is a signaling diagram 600, comprising the combination of Part A 601, Part B 603, Part C 605, Part D 607, Part E 609 and Part F 611, of an exemplary method of operating a communications system, including a chatbot 104 and a network performance recommendation engine (NPRE) 106, to perform troubleshooting of a problem reported by a customer, identify potential corrective actions and implement corrective actions in accordance with an exemplary embodiment.

In step 602, the performance management (PM) module 150 of the network management module 146 of the operations support system (OSS) 144, based on detected monitored performance information from base stations (BS A 134, BS B 136, BS C 138, BS D 140) generates and sends performance messages 604, e.g., KPI messages and messages conveying performance statistics, to messaging repository 114. In step 606 the messaging repository 114 receives the performance messages 604, and in step 608 the messaging repository 114 stores the received performance information in PM store 122.

In step 609, the fault management (FM) module 152 of the network management module 146 of the operations support system (OSS) 144, based on detected monitored fault information from devices including base stations (BS A 134, BS B 136, BS C 138, BS D 140) generates and sends fault messages 610, e.g., alarms, and/or detected/reported faults, to messaging repository 114. In step 611 the messaging repository 114 receives the fault messages 610, and in step 612 the messaging repository 114 stores the received fault information in FM store 124.

In step 614 the UE 140, based on customer input, generates and sends a report 615 of a network performance problem to chatbot 104. In step 616 chatbot 104 receives the customer network performance problem report 615 and recovers the communicated information.

In step 617, the chatbot 104 is operated to collect location information/address associated with a problem, e.g., collect a geo code or an address, associated with a problem reported by the customer operating UE 140, which is contacting the chatbot 104. Step 617 includes steps 618, 628, 630, and 640.

In step 618 the chatbot 104 generates and sends message 620, which communicates “Whom do I have the pleasure of speaking with?” to UE 140. In step 622 UE 140 receives message 622 and presents the message to the customer. In step 624 the UE 140 receives input from the customer, generates and sends message 626, which communicates “My name is SAM. I have a network issue right now” to the chatbot 104. In step 628 the chatbot 104 receives message 626 and recovers the communicated information. In step 630 the chatbot 104 generates and sends message 632, communicating “May I have your number and address please” to the UE 140. In step 634 UE 140 receives message 632 and presents the message to the customer. In step 636 the UE 140 receives input from the customer, generates and sends message 638, which communicates “123-456-7890, address: Crescent Drive, Charlotte, NC 28217” to the chatbot. In step 640 the chatbot 104 receives message 638 and recovers the communicated information, which is a customer phone number and address, representing the current location of the customer using UE 140.

In step 642 the chatbot 104 generates and sends message 644, communicating “Wait a moment” to the UE 140. In step 644, UE 140 receives message 644 and presents the message contents to the customer.

In step 648 the chatbot 104 identifies the location, e.g., the reported problem location within the system and the current location of the customer, based on the information received from the customer. In step 649 the chatbot retrieves serving and neighbor cell information corresponding to UE 140. Step 649 includes steps 650 and 654. In step 650 the chatbot 104 generates and sends request message 653 to configuration management (CM) module 148, said request message 653 including UE ID information, location information, said request message 653 requesting serving and neighbor cell information, corresponding to UE 140. In step 654, CM module 148 receives request message 654 and in step 656 sends request 658, e.g., a forwarded copy of request 652, to core network 126. In step 660 the core network 126 receives request message 658, and in response, in step 662, the core network 126, generates and sends a request message 664, e.g., a forwarded copy of request 658, to data base 128. In step 666, database 128 receives the request, and in step 668, the database 128 generates and sends response message 670, which includes the serving and neighbor cell information, which was requested. In step 672 core network receives response message 670, and forwards the response messing in step 672, as response message 676 to CM module 148. In step 678 the CM module 148 receives the response 676 including serving and neighbor cell information, and in step 682 the CM module 148 sends the response as message 682 to chatbot 104. In step 684 the chatbot receives the response message 682 and recovers the communicated serving and neighbor cell information. In step 686 the chatbot captures the timestamp and associates it with the retrieved serving and neighbor cell information.

In step 687 the chatbot is operated to collect problem information from the customer using UE 140. Step 687 includes steps 688, 698, 700, 710, 712 and 724. In step 688 the chatbot generates and sends message 690, which communicates “How often do you have the problem?” to the UE 140. In step 690, UE 140 receives message 690 and presents the communicated information to the customer operating UE 140. In step 694, UE 140 receives input from the customer and generates and sends message 696, which communicates “Always when I am nearby this location” to the chatbot 104. In step 698 the chatbot receives message 696 and recovers the communicated information. In step 700 the chatbot generates and sends message 702, which communicates “What type of services do you use when you get the network issue?” to the UE 140. In step 704, UE 140 receives message 702 and presents the communicated information to the customer operating UE 140. In step 706, UE 140 receives input from the customer and generates and sends message 708, which communicates “Phone calls” to the chatbot 104. In step 710 the chatbot 104 receives message 708 and recovers the communicated information. In step 712 the chatbot 104 generates and sends message 714, which communicates “Do you have issues only at this location or other locations as well?” to the UE 140. In step 716, UE 140 receives message 714 and presents the communicated information to the customer operating UE 140. In step 718, UE 140 receives input from the customer and generates and sends message 720, which communicates “No, only at this location, rest of the places are just fine” to the chatbot 104. In step 724 the chatbot receives message 720 and recovers the communicated information.

In step 725 the chatbot 104 is operated to update customer record information to reflect the reported issue. Step 725 includes step 728, in which the chatbot 104 generates and sends customer message record update information 728, which includes the reported problem issue, information identifying the customer and/or customer device, and time tag information. In some embodiments, the customer message update information further includes one or more of: information identifying serving and/or neighbor cell, problem location information, and collected problem related information, e.g., problem frequency, type of services associated with problem, single or multiple locations. In step 730 the messaging repository receives customer message record update information 728, and in step 732 the messaging repository 114 updates customer record information in customer messages store 116 to reflect the reported problem.

In step 734 the chatbot 104 generates and sends message 736, communicating “Can you click OK to authorize and help us to collect data (on push notification)” to the UE 140. In step 738, UE 140 receives message 738 and presents the message contents to the customer. In step 740, UE 140 detects that the operation has clicked OK, and in response sends message 742, indicating clicked OK, to chatbot 104. In step 744, chatbot 104 receives message 742 conveying the click Ok indication. In step 746, UE 140 generates sends customer message 748, which communicates “Yes, done”, to chatbot 104. In step 750, chatbot 104 receives message 748 and recovers the communicated information.

In step 751, in response to the positive response of steps 744 and 750, the chatbot performs step 751, in which the chatbot recovers UE 140 configuration information. Step 751 includes steps 752 and 758. In step 752 chatbot 104 generates and sends a request 754 for UE 140 configuration information to CM 148. In step 756 CM 148 receives the request for UE configuration information 754, and in response in step 758 generates and sends a request for UE 140 configuration information 760, e.g., a forward copy of request 754, to core network 126, which receives the request 760 in step 762. In step 764, the core network sends a request 766 for UE 140 configuration information to database 128. In step 769 database 128 receives the request 766. In response to the received request 766, in step 770 database 128 generates and sends a response including the requested UE 140 configuration information. In step 774, core network 126 receives the response, and in step 776 generates and sends response 778 including the retrieved UE 140 configuration information to CM 148. In step 780 CM 148 receives the response 780 including the UE 140 configuration information, and in step 782 the CM 148 sends response message 784 including the UE 140 configuration information to chatbot 104. In step 786 chatbot 104 receives response message 784 and recovers the communicated UE 140 configuration information.

In step 788 the chatbot 104 generates and sends message 790, to trigger sending of packet(s) to UE 140 and collecting of measurement data, to core network 126. In step 792 the core network 126 receives message 790 and recovers the communicated information.

In step 794 chatbot 104 sends message 796 to UE 140, which communicates “We are collecting measurement information”. In step 798 UE 140 receives message 796 and presents the message contents to the customer. In step 800, UE 140 generates sends customer message 802, which communicates “Sure”, to chatbot 104. In step 804, chatbot 104 receives message 802 and recovers the communicated information.

In step 806 core network 806 generates and sends a message 808 to trigger sending of packet(s) to UE 140 and collecting of measurement data to base station B 136, which receives message 808 and recovers the communicated information in step 810. In step 812, in response to received message 810, base station B 136 generates and sends packet(s) 814 to UE 140, which are received by UE 140 in step 816. In step 816 UE 140 performs measurements on the received signals of step 816, e.g., received signal power measurements, e.g., RSRP, received signal quality measurement, e.g., RSRQ and/or bit error rate, interference measurements, e.g., SNR, SINR, etc.

In step 820 core network 806 generates and sends a message 822 to trigger sending of packet(s) to UE 140 and collecting of measurement data to base station C 138, which receives message 822 and recovers the communicated information in step 824. In step 826, in response to received message 822, base station C 138 generates and sends packet(s) 828 to UE 140, which are received by UE 140 in step 830. In step 832 UE 140 performs measurements on the received signals of step 828, e.g., received signal power measurements, e.g., RSRP, received signal quality measurement, e.g., RSRQ and/or bit error rate, interference measurements, e.g., SNR, SINR, etc.

In this example, the chatbot has selected base station B 136 and base station C 138 to be used to send packets, e.g., test packets for evaluation purposes, to UE 140.

In step 834 UE 140 generates and sends a measurement report 836 to base station B 136, said measurement report 836 including measurement information of step 818 (corresponding to base station B 136 packets) and measurement information of step 832 (corresponding to base station B 136 packets). In step 838 base station B 136 receives the measurement report 836, and in step 840 base station B 136 generates and sends measurement report 842, e.g., a forwarded copy of measurement report 836, to core network 126. In step 843 core network 126 receives the measurement report 842, and in step 844 core network 126 generates and sends measurement report 846, e.g., a forwarded copy of measurement report 842, to chatbot 104.

In step 848 chatbot 104 receives measurement report 846 and recovers the communicated information. In step 850 the chatbot 104 augments the measurement report with time/location information. In step 852 chatbot sends measurement report with time and location information 854 to messaging repository 114. In step 856 messaging repository 114 receives measurement report with time and location information 854 and recovers the communicated information. In step 858, the messaging repository 114 stores the received measurement report with time and location information, e.g., in store 118.

In step 860 chatbot 104 generates and sends request message 862 to NPRE 106, said request message 862 requesting: analysis of the customer reported problem, a root cause determination, and a correction recommendation. In step 864, NPRE 106 receives the request 862 for analysis of the problem, root cause determination, and correction recommendation. In step 866 NPRE 106 generates and sends a request 868 for a set of stored measurement data. In step 870, the NPRE 106 receives request 868, and in response in step 870 the messaging repository 114 retrieves the requested measurement data and sends message 874 communicating the retrieved set of requested measurement data to NPRE 106. In step 876 the NPRE 106 receives message 874 and recovers the set of requested measurement data.

In step 878 the NPRE performs an analysis, which includes step 880 in which the NPRE analyzes the serving cell health, e.g., cell B health, and step 882 in which the NPRE 106 analyzes the condition specific to the customer which reported the network performance problem at a specific location. In step 884, the NPRE 106 determines a root cause of the problem. In step 886, the NPRE 106 determines a corrective action(s) to be automatically implemented and/or suggested to a network engineer, e.g., using a corrective action predication model.

In step 888, NPRE 106 generates and sends response message 890 to chatbot 104, said message 890 including a recommended correction action, e.g., configuration changes. In step 892 chatbot 104 receives message 892 and recovers the communicated recommended corrective action.

In some embodiments, implementation of a recommended corrective action from the NPRE 106 is subject to approval by a network engineer, and steps 8921, 8923, 8924, 8925, and 8927 are performed. In other embodiments, steps 8921, 8923, 8924, 8925, and 8927 are bypassed.

In step 8921 chatbot generates and sends message 8922 to UE 142, which is a UE operated by a network engineer (NE), said message 8922 conveying information on the customer reported problem and the recommended corrective action. In step 8923 UE 142 receives message 8922, recovers the communicated information, and presents the recovered information to the network engineer operating UE 142 for an evaluation decision. In step 8924, UE 142 receives input from the network engineer communication the evaluation decision, e.g., implement the recommended change or refrain from implementing the recommended change. In step 8925 UE 142 generates and sends a response command message 8926 to chatbot 104, e.g., a command message to implement the recommended network change. In step 8927, chatbot 104 receives message 8926 and recovers the communicated information, e.g., a command to implement the recommended change.

In step 893 chatbot 104 is operated to implement changes. Step 893 includes step 894, in which chatbot 104 generates and message 896 to CM 148, said message 896 including a recommended corrective action, e.g., configuration changes, which are to be implemented. In step 898, CM 148 receives message 896 and recovers the communicated information. In step 900 CM 148 generates and sends message 902, including configuration changes, e.g. power level adjustments and/or antenna adjustment information for one or more base stations, to core network 904, which receives the message 902 in step 904. In step 906 the core network 126 sends message 908 to database (DB) 128 to store updated configuration information, and in step 910 the database receives message 908, and stores the received updated configuration information. In some embodiments DB 128 is a unified data repository which is part of the core network 126.

In step 912 core network 126 generates and sends a command to update configuration information 914, which includes the configuration changes of message 902 to base station B 136. In step 916 base station B 136 receives configuration update message 914, and in response in step 918 base station B 136 updates configuration information and proceeds to operate in accordance with the new configuration, e.g. at a higher power level and/or with a different antenna directivity.

In step 919 chatbot 104 reports back to the customer. Step 919 includes step 920 in which chatbot 104 generates and sends message 922 to UE 140, which communicates “Changes have been made to address your problem.” In step 923 UE 140 receives message 922 and presents the communicated message to the customer, which is the operator of UE 140.

In step 924 the chatbot 104 determines whether the change was successful or unsuccessful in resolving the problem based on customer feedback and/or network performance. Step 924 includes step 925 and/or step 954, e.g. depending upon the particular implementation.

In step 925 chatbot 104 determines whether the change was successful or unsuccessful in resolving the problem based on customer feedback. Step 925 includes steps 926, 936, 938, 948, and one of step 950 or 952 for an iteration of step 925.

In step 926 chatbot 104 generates and sends message 928, which communicates “Can you try making another call?” to UE 140. In step 930, UE 140 receives message 928 and presents the communicated information to the customer. In step 932 UE 140 receives input from the customer and generates and sends message 934, communicating “Sure” to the chatbot 104, which, in step 936, receives message 934 and recovers the communicated information. In step 938 chatbot 104 generates and sends message 940, which communicates “Is your problem resolved?” to UE 140. In step 942, UE 140 receives message 940 and presents the communicated information to the customer. In step 942 UE 140 receives input from the customer and generates and sends message 946, communicating a response, e.g. “Yes it look fixed. Thank You,” or “No”, to the chatbot 104, which, in step 948, receives message 946 and recovers the communicated information. Based on the whether the information in message 948 is positive or negative, the chatbot 104 performs step 950, in which the chatbot determines that the problem has been solved from positive customer feedback or performs step 952 in which the chatbot 104 determines that the problem has not been solved from negative customer feedback.

In step 954 chatbot 104 determines whether the change was successful or unsuccessful in resolving the problem based on network performance information. Step 954 includes steps 956, 968, and one of step 970 or 972 for an iteration of step 954. In step 956 chatbot 104 generates and sends an evaluation request 958 to NPRE 106, which receives the request in step 960. In step 962 NPRE 106 performs the requested evaluation, said requested evaluation including accessing performance information and comparing pre-change to post-change performance information to determine whether or not the implemented change has resulted in an improvement in network performance. In step 964 NPRE 106 generates and sends an evaluation response 966 to chatbot 104, which receives the evaluation response 966 in step 968 and recovers the communicated evaluation determination, e.g. an improvement in performance, no change in performance or degradation in performance. In some embodiments, the response may, and sometimes does, include information indicating a level of change in performance, e.g., an amount of improvement in performance. In step 970 chatbot 104 determines that the problem has been solved from an improvement in network performance. In some embodiments, the improvement in performance has to be above a predetermined threshold for the problem to be deemed solved. Alternatively, in step 972 the chatbot 104 determines that the problem has not been solved from no change network performance or a degradation in network performance or an insufficient amount of improvement in network performance.

In step 974 chatbot is operated to update stored information corresponding to the reported problem to indicate whether the implemented change was successful or unsuccessful in resolving the problem. Step 974 includes step 976, in which chatbot 104 generates and sends an updated message 978 to messaging repository 114, said update message indicating if the change was successful or unsuccessful to resolve the reported network performance problem. In step 980 messaging repository receives message 980 and recovers the communicated information. In step 982 messaging repository 114 updated stored information corresponding to the reported problem to indicate whether the implemented change was successful or unsuccessful in resolving the problem.

The information on whether a particular network change, e.g., a recommended change such as changing a base station transmit power or antenna configuration to solve a reported problem is useful in training a corrective action prediction model since it is reliable information which can be used to increase the reliability of future corrective action recommendations with the corrective action prediction module by decreasing the chance that unsuccessful corrective actions will be recommend and that successful corrective actions will be recommended.

In step 984 the chatbot 104 requests a corrective action prediction model training operation be implemented using the stored information corresponding to the reported problem, e.g., the problem description and location information, along with the information indicating the corrective action which was taken in an attempt to correct the problem and whether the corrective action was successful or not successful. Step 984 includes step 9841, in which the chatbot 104 generates and sends request for model retraining message 9842 to NPRE 106. The request 9842 for the corrective action prediction module training operation is sent to the NPRE 106, which is responsible for corrective action prediction model training, e.g., updating, as new information becomes available. In step 9843 the NPRE 106 receives the request 9842 for corrective action prediction model retraining, and then in step 9844 performs the corrective action prediction model training operation using the stored information corresponding to the reported problem, the corrective action taken and whether the action was successful or unsuccessful. Once the corrective action predictive model training has been completed and the model updated, the NPRE 106 will not recommend a previously failed, i.e., unsuccessful, corrective action in response to the same problem again.

In step 9845 the NPRE 106 reports to the chatbot 104 that retraining of the corrective action prediction model has been completed. In step 9845 NPRE 106 generates and sends model training complete message 9846 to chatbot 104, which receives the model training complete message 9846 in step 9847.

While in the FIG. 6F example the chatbot initiates retraining of the corrective action prediction model used to provide corrective action predictions and in some but not all embodiments root cause determinations, the corrective action prediction model updating process can be performed periodically or non a scheduled basis used the stored updated information in the message repository. In such an embodiment the corrective action prediction model will be updated, e.g., retrained, on a regular basis as information becomes available as to what corrective actions are unsuccessful or successful at resolving various reported problems. This results in improvements over time in the corrective action prediction model without necessarily requiring the chatbot to trigger the model retraining, e.g., updating, process.

With success or failure of a corrective action known, operation proceeds to step 986 from step 874 in cases where the corrective action prediction model update is not triggered by the chatbot 104, e.g., when the model update is performed periodically, or from step 9847 to step 986 in those implementations where the chatbot 904 triggers the corrective action predictive model update.

In step 986 a check is made as to whether the implemented change, e.g., corrective network action, taken to address the reported problem was successful with regard to resolving the reported problem was successful, e.g., resolved the reported problem, or unsuccessful, e.g., did not resolve the reported network problem.

If in step 986 it is determined that the implemented change was unsuccessful at resolving the network problem operation the network change which was made in an attempt to resolve the reported problem is rolled back, e.g., reversed, since it was unsuccessful and operation proceeds once again to step 860 so that the chatbot can generate another request for analysis of the problem, root cause determination and correction recommendation. The repeated request for analysis and a corrective action recommendation is sent to the NPRE 106 as part of another iteration of steps 860 through 986 with this repeated iteration having been triggered by the fact that the previously performed corrective action was unsuccessful.

In subsequent iteration of step 886 the NPRE 106 will use the updated, e.g., retrained corrective action prediction model that was improved by the retraining performed in step 9844. As a result of the model retraining the failed corrective action will not be provided in response to the repeated request for analysis and a corrective action recommendation generated during the subsequent iteration of step 860 will be different from the previously recommended corrective action provided with respect to the same previously reported and analyzed problem.

In some embodiments to make sure that a corrective action that failed will not be repeated in response to a previously reported problem, in step 986 in response to determining that a corrective action was unsuccessful, in addition to proceeding to another iteration of step 860 the previously failed corrective action is provided as an input to step 860 and included in the request for analysis and correction recommendation sent to the NPRE 106 with the previously implemented corrective action being identified as a corrective action which is not to be recommended in response to the problem. For example, if an increase in BS transmit power was recommended and specified in step 888 to the chatbot 104 but this failed to resolve the reported problem, the next time, e.g., the second time, the chatbot 104 requests analysis and a correction recommendation in response to the same problem, the chatbot will indicate that an increase in BS transmit power is not to be recommended. In such embodiments the NPRE 106 will be sure to suggest a different corrective action such as BS antenna reconfiguration, e.g., change in orientation and/or a change in one or more BS antenna array gain and phase control parameters at the BS providing service to the coverage area where the reported problem was encountered. Thus, a second recommended corrective action will be different from a first recommend corrective action provided with response to a specific reported network problem.

With each iteration through step 860 and the subsequent steps, a new corrective action will be recommended and tried and the corrective action prediction model updated based on the knowledge gained as to what corrective action eventually works and what corrective actions failed to resolve the reported problem. Thus, second, third and even more corrective actions can be taken until one succeeds. Knowledge is gained and used to update the corrective prediction model with each attempt to resolve a reported problem whether the attempt is successful or unsuccessful.

If in step 986 it is determined that the implemented change was successful, operation proceeds to step 988 in which the chatbot decides to update the customer message database based on the customer feedback, e.g., feedback indicating successful resolution of the repotted problem. The chatbot in step 990 sends a customer message record update to the messaging repository t 114 regarding the reported problem and indicating the customer's final feedback, e.g., successful problem resolution in the case where the reported problem was successful resolved. In step 994 the messaging repository 114 receives the customer message record update information 992. In step 996 the messaging repository 114 stores the customer provided feedback relating to the reported problem with information identifying the user reporting the problem and/or identify the user device 140 to which the feedback information being stored relates.

While storage of the customer feedback information 996 represents completion of the handling of the problem reported in step 614, the chatbot remains available to respond to additional reports of problems and/or network engineer inquiries on an ongoing basis.

FIG. 7, comprising the combination of FIG. 7A, FIG. 7B, FIG. 7C, FIG. 7D, FIG. 7E, FIG. 7F and FIG. 7G, is a signaling diagram 1000, comprising the combination of Part A 1001, Part B 1003, Part C 1005, Part D 1007, Part E 1009, Part F 1011 and Part G 1013, of an exemplary method of operating a communications system including a chatbot 104 and a network performance recommendation engine (NPRE) 106 to perform support to a network engineer (NE) reviewing of network conditions, e.g., real or near real time conditions, said support including identifying cells with poor performance, performing root cause analysis and providing possible corrective actions, in accordance with an exemplary embodiment.

In step 1002 of FIG. 7A, the performance management (PM) module 150 of the network management module 146 of the operations support system (OSS) 144, based on detected monitored performance information from base stations (BS A 134, BS B 136, BS C 138, BS D 140) generates and sends performance messages 1004, e.g., KPI messages and messages conveying performance statistics, to messaging repository 114. In step 1006 the messaging repository 114 receives the performance messages 1004, and in step 1008 the messaging repository 114 stores the received performance information in PM store 122.

In step 1010, the fault management (FM) module 152 of the network management module 146 of the operations support system (OSS) 144, based on detected monitored fault information from devices including base stations (BS A 134, BS B 136, BS C 138, BS D 140) generates and sends fault messages 1012, e.g., alarms, and/or detected/reported faults, to messaging repository 114. In step 1014 the messaging repository 114 receives the fault messages 1012, and in step 1016 the messaging repository 1114 stores the received fault information in FM store 124.

In step 1018 the UE 142, based on network engineer (NE) input, generates and sends message 1020, which communicates “Can you provide me with a list of cells (top 10) suffering from poor network accessibility (e.g., area with UEs reporting low signal strength and/or a high rate of connection attempt failures) in the area?” to chatbot 104. In step 1021 chatbot 104 is operated to receive a request for information. Step 1021 includes step 1022 in which the chatbot 104 receives message 1020 and recovers the communicated information indicating that the network engineer is requesting a list of cells (top 10) suffering from poor network accessibility in the area.

In step 1023 chatbot 104 is operated to request location information. Step 1023 includes step 1024, in which the chatbot 104 generates and sends message 1026, which communicates “Please provide the area name or zipcode of the area of interest” to UE 142. In step 1028, UE 142 receives message 1026, recovers the communicated information and presents the communicated information to the network engineer, which is the operator of UE 142. In step 1028, UE 142 receives the zipcode as input from the network engineer, generates message 1032, which communicates “Zip 12345”, and sends message 1032 to the chatbot 104. In step 1033 chatbot 104 is operated to receive and optionally confirm location information. Step 1033 includes steps 1034, and in embodiments including a confirmation further includes steps 1036 and 1038. In step 1033 chatbot receives message 1032 and recovers the communicated information “Zip 12345”. In step 1036 the chatbot determines a corresponding address, e.g., based on location tracking information corresponding to UE 142 and/or based on the received information, e.g. zipcode, sent from UE 142, generates message 1038, which communicates “OK. This zipcode belongs to Cresent Dr., Charlotte, NC. Is this correct?” and sends message 1038 to UE 142. In step 1040 UE 142 receives message 1038, recovers the communicated information and presents the recovered information to the network engineer. In step 1042 UE 142 receives input “Yes” from the network engineer, generates message 1044, which communicates “Yes”, and sends message 1044 to chatbot 104. In step 1046 chatbot 104 receives message 1046 and recovers the communicated information, which provides positive confirmation of the location.

In step 1047 the chatbot is operated to request a time period of interest relating to the information request. Step 1047 includes step 1048, in which the chatbot 104 generates and sends message 1050, which communicates “What is the duration of the report you are looking for?” to UE 142. In step 1052 UE 142 receives message 1050, recovers the communicated information and presents the communicated information to the network engineer. In step 1054 UE 142 receives a response input “Last two days” from the network engineer, generates message 1056, which communicates “Last two days”, and sends message 1056 to chatbot 104.

In step 1057 chatbot 104 is operated to receive time period information. Step 1057 includes step 1058, in which UE 142 receives message 1056, recovers the communicated information indicating that the time period of interest for the requested report is “Last two days”.

In step 1060 chatbot 104 generates and sends request message 1062 to NPRE 106. Request message 1062 requests the NPRE 106 to perform one or more or all of: i) identify cells with the performance problem of interest, e.g. poor network accessibility, ii) list identified cells in order based on severity of problem at identified cells, ii) perform root cause analysis of problem at cells and determine a corresponding solution, iv) generate cell list, e.g., cell list on severity of problem limited to request number of cells, and v) determine possible corrective actions corresponding to identified root causes of problem (e.g., poor network accessibility), said request identifying the location and time period of interest. In step 1064, NPRE 106 receives request message 1062 and recovers the communicated information. In response to the received request message 1062 of step 1064 operation proceeds to step 1065 of FIG. 7B.

In step 1065 NPRE 106 is operated to access cell accessibility information, KPIs and performance counters corresponding to the location and time period of interest, indicated in the request message 1062. Step 1065 includes steps 1066 and 1078. In step 1066 NPRE 106 generates and sends request message 1068 to messaging repository 114. Request message 1068 requests: cell accessibility information, KPIs and performance counters corresponding to the location and time period of interest. In step 1070 messaging repository 114 receives request message 1068 and recovers the communication information. In step 1072, the messaging repository 114 retrieves the requested information, and in step 1074 the messaging repository 114 generates and sends response 1076 to NPRE 106. Response 1076 includes cell accessibility information, KPIs and performance counters corresponding to the location and time period of interest. In step 1078 NPRE 106 receives response message 1078 and recovers the communicated information.

In step 1080 NPRE 106 generates and sends a request for fault information 1082 corresponding to the location of interest and a time period which includes the time period of interest to the messaging repository 114. In step 1084 the messaging repository 114 receives the fault information request message 1082 and recovers the communicated information. In step 1086 the messaging repository 114 retrieves the requested fault information. In step 108 the messaging repository generates and sends response message 1089, including the retrieved requested fault information, to NPRE 106. In step 1090 NPRE 106 receives response message 1089 and recovers the communicated information. Operation proceeds from step 1090 to step 1092 of FIG. 7C.

In step 1092 NPRE 106 identifies cells with the performance problem of interest, e.g. poor network accessibility. In step 1094 NPRE 106 lists identified cells in order based on the severity of the problem at the identified cells. In step 1096 NPRE 106 performs a root cause analysis to identify cause of the problem at cells and a corresponding solution. In step 1098 NPRE 106 generates a list, e.g., a cell list ordered based on severity of the problem limited to the requested number of cells. In step 1100 NPRE 106 determines possible corrective actions corresponding to identified root cause(s) of problem (e.g., poor network accessibility), e.g., using a corrective action prediction model.

In step 1102 NPRE generates and sends response message 1104 to chatbot 104. Response message 1102 includes one or more or all of: i) information indicating identified cells with the performance problem of interest, e.g., poor network accessibility, ii) a list of identified cells in order based on severity of the problem at identified cells, iii) root cause analysis result of problems at cells and determined corresponding solution, iv) a generated list, e.g., cell list based on severity of problem limited to request number of cells, and v) determined possible corrective actions corresponding to the identified root causes of problem (e.g., poor network accessibility). In step 1106 chatbot 104 receives response message 1104 and recovers the communicated information. Operation proceeds from step 1106 to step 1107 of FIG. 7D.

In step 1107 chatbot 104 is operated to provide a list of cells with the problem and recommended corrective action to the network engineer. Step 1107 includes step 1108, 1114, and 1120. In step 1108 chatbot 104 generates and sends message 1110, which communicates “Here is a list of cells with root cause analysis for the requested time period, e.g., last wo days, along with recommended corrective actions”, to UE 142. In step 1112 UE 142 receives message 1110, recovers the communicated information, and presents the recovered message information to the network engineer. In step 1114 chatbot 104 generates and sends message 1116, which communicates a list of cells, to UE 142. In step 1118 UE 142 receives message 1116, recovers the communicated information, and presents the list of cells to the network engineer. In step 1120 chatbot 104 generates and sends message 1122, which communicates “Suggested corrective action is to modify cell transmit power, antenna directivity and/or modify cell configuration”, to UE 142. In step 1124 UE 142 receives message 1122, recovers the communicated information, and presents the recovered communicated message information to the network engineer.

In step 1125 the chatbot 104 is operated to prompt the network engineer (NE), which is the user of UE 142, for action to be taken. Step 1125 includes step 1126, in which the chatbot 104 generates and sends message 1128, which communicates “What action would you like to take?” to UE 142. In step 1130 UE 142 receives message 1128, recovers the communicated information, and presents the recovered communicated message information to the network engineer. In step 1132 UE 142 receives input from the network engineer, generates message 1134 based on the received input from the network engineer, and sends message 1134 to chatbot 104. Message 1134 communicates network engineer specified corrective action(s), from the suggested corrective actions of message 1122, to be performed (e.g., implemented) for one or more specified BSs, e.g., increase maximum power at BS A 134 and change orientation of antenna at BS A 134. In step 1135 chatbot 104 is operated to receive actions instructions with regard to one or more base stations. Step 1135 includes step 1136 includes step 1136 in which chatbot 104 receive message 1134, and recovers the communicated instruction information, which indicates the network engineer (NE) specified corrective action(s) to be performed (e.g., implemented) for one or more BSs, e.g., increase maximum power at BS A 134 and change orientation of antenna at BS A 134.

In step 1137 chatbot 104 implements the request action(s), indicated in received message 1134, by making network change(s). Step 1137 includes step 1138, in which the chatbot 104 generates and sends message 1140 to configuration management (CM) module 148 of network management module 146 of operation support system (OSS) 144. Message 1140 includes a command to implement the requested change(s), e.g., increase maximum power at BS A 134 and change orientation of antenna at BS A 134. In step 1142 CM 148 receives message 1140 and recovers the communicated information. In response to receiving message 1140, in step 1144 CM 148 generates and sends message 1146, e.g., a command message to implement the requested change(s), e.g., increase maximum power change at BS A 134 and change orientation of antenna at BS A 134, which is directed to core network 126 to be delivered to BS A 134, for implementation of the configuration update, and, in some embodiments, to database 128, for storage of the new configuration.

In step 1148 core network 126 receives command message 1146 to implement the requested changes, e.g., perform configuration update at BS A 134. In step 1150, included in some embodiments, the change information, e.g. configuration update information, e.g., corresponding to BS A 134, is sent via message 1152 to database 128. In step 1154 DB 128 receives message 1152 and in step 1156 database stores the updated configuration information, e.g. corresponding to BS A 128, e.g., in system configuration information 130. In step 1158, included in some embodiments, the change information, e.g. configuration update information, e.g., corresponding to BS A 134, is sent via message 1160 to base station A (BS A) 134. In some embodiments, message 1160 is a forwarded copy of message 1146. In step 1162 BS A 134 receives message 1160 and recovers the communicated configuration update command, e.g., increase maximum power, e.g., to a specified level, and change antenna orientation, e.g. to a specified antenna orientation. In step 1164 BS A 134 performs the configuration update, as specified in received message 1160, e.g., changing the maximum power level and changing the antenna orientation, and then operates BS A 134 in accordance with the updated configuration.

Operation proceeds from step 1164 to step 1166 of FIG. 7E. In step 1166 BS A 134 generates and sends performance reports (KPIs, etc.) 1168, e.g., which were generated based on received measurement reports from UEs and/or measurements at BS A 134, to core network 126, which receives the performance reports 1168 in step 1170. In step 1172 BS B 136 generates and sends performance reports (KPIs, etc.) 1174, e.g., which were generated based on received measurement reports from UEs and/or measurements at BS B 136, to core network 126, which receives the performance reports 1174 in step 1176. In step 178 BS C 138 generates and sends performance reports (KPIs, etc.) 118, e.g., which were generated based on received measurement reports from UEs and/or measurements at BS C 138, to core network 126, which receives the performance reports 1180 in step 1182. In step 1184 BS D 139 generates and sends performance reports (KPIs, etc.) 1186, e.g., which were generated based on received measurement reports from UEs and/or measurements at BS D 139, to core network 126, which receives the performance reports 1186 in step 1188. In step 1190 core network 126 generates and sends performance reports (KPI, etc.) for a set of BSs 1192, to performance management (PM) module 150 of network management module 146 of OSS 144, said set of BSs including BS A 134, BS B 136, BS C 138 and BS D 139. In step 1194, PM 150 receives performance reports 1194, and in response, in step 1196 PM 150 generates and sends performance reports (KPI, etc.) 1198, e.g., for a set of BSs, to messaging repository 114. In step 1200 the messaging repository 114 receives the performance reports and in step 1202 the messaging repository 114 stores the received performance reports in the PM store 122 of the messaging repository 114.

In step 1203 the chatbot is operated to monitor network performance metrics following the implemented action(s), e.g., implemented configuration change(s). Step 1203 includes step 1204 and step 1216. In step 1204 chatbot 104 generates and sends a request 1206 for network performance metrics (e.g., KPIs, etc.) relevant to the change (e.g., for BS A 134) for a time interval following the change to the messaging repository 114. In some embodiment, the request may include network performance metrics for additional cells, e.g., adjacent cells to the cell which implemented a configuration change, e.g., which might be negatively impacted. In step 1208 the messaging repository 114 receives the request 1208, and in step 1210 the messaging repository 114 retrieves the requested performance information. In step 1212 the messaging repository generates and sends response message 1214 including the retrieved requested performance information to chatbot 104. In step 1216 chatbot 104 receives response message 1214 and recovers the communicated retrieved requested performance information, e.g. for BS A 134.

In step 1218 chatbot 104 sends post change performance information 1220, recovered in message 1214, to NPRE 106. In step 1222 NPRE 106 receives and recovers the communicated post change performance information 1220.

In step 1224 chatbot 104 generates and sends request message 1226 to NPRE 106, said request message 1226 requesting the NPRE to perform an evaluation as to whether the problem has been resolved and/or performance has improved. In step 1228 NPRE receives the evaluation request message 1226. In step 1230 NPRE 106 evaluates the effect of the change, e.g., the implemented configuration changes at BS A 134, e.g., based on a comparison of pre-change performance information to post-change performance information, e.g., to determine the effect on network performance of the implemented action, i.e., was the problem resolved or performance improved. In step 1232 the NPRE 106 generates and sends an evaluation result 1234, e.g., indicating an improvement in performance or indicating a degradation in performance, to chatbot 104. In step 1236 chatbot 104 receives evaluation result message 1234 and recovers the communicated information. Operation proceeds from step 1236 to step 1237 of FIG. 7F.

In step 1237 chatbot 104 is operated to report to the network engineer, which is operating UE 142, on the effect on the network, e.g., improvement in network performance or degradation in network performance, depending upon the detected effect, e.g., of evaluation result received in message 1234. Step 1237 includes step 1238, in which the chatbot generates and send message 1240, which communicates the evaluation result, e.g. for the case of a positive evaluation result message 1240 communicates “Network performance has improved at the base station(s) which were previously suffering the most for the problem you asked about, e.g., accessibility problems”, to UE 142. In step 1242 UE 142 receives message 1242 and presents the communicated information, e.g., indicating that the network performance has improved, to the network engineer. In some embodiments, message 1240 also includes evaluation data, e.g., from the NPRE, on a detected level or improvement or degradation at each one or more base stations, e.g., a base station for which configuration was changed and adjacent base station, which may be impacted by the change.

In step 1243 chatbot is operated to prompt the network engineer (NE), which is the user of UE 142, as to whether: i) the network change should be maintained or ii) the network should be restored to pre-change condition. Step 1243 includes step 1244 in which chatbot 104 sends message 1246, which communicates “Do you want to keep or rollback the network change?” to UE 142. In step 148 UE 142 receives message 1246 and presents the communicated information, with the option to keep or rollback the change, to the network engineer.

In step 1250, UE 142 receives input from the network engineer, generates message 1252 which includes a NE instruction, e.g. maintain change or rollback change, and sends message 1252 to chatbot 104. In step 1253 chatbot 104 is operated to receive an instruction from the network engineer. Step 1253 includes step 1254, in which chatbot 104 receives instruction message 1252, e.g., which communicates maintain change or alternatively communicates rollback change.

In step 1255 chatbot 104 implements the received instruction of message 1252. Step 1255 includes one or step 1256 or step 1264 for each iteration of step 1255. If the received instruction of message 1252 was to maintain the change, then chatbot 104 performs step 1256, in which chatbot 104 generates and sends maintain change message 1258 to CM 148. CM 148 receives maintain change message in step 1260, and in response in step 1262 CM 148 is operated to lock-in the change.

Alternatively, if the received instruction of message 1252 was to rollback the change, then chatbot 104 performs step 1264, in which chatbot 104 generates and sends rollback change message 1266 to CM 148. CM 148 receives rollback change message 1266 in step 1268, and in response in step 1270 CM 148 generates and sends rollback change message 1272 to core network 126, which receives message 1272 in step 1274. In step 1276, core network 126 generates and sends restore pre-change configuration message 1278 to database 1280, which receives message 1278 in step 1280 and in step 1282 restores the pre-change configuration, e.g. for base station A 134, in system configuration information 130 of database 128. In step 1284 core network 126 generates and sends command message 1286 to base station A 134, which commands BS A 134 to change back to the pre-change configuration settings. In step 1288 BS A 134 receives message 1286 and recovers the communicated information. In response to receiving message 1286, in step 1290 BS A 134 performs an update, e.g., BS A 134 changes maximum power and antenna orientation back to the pre-change settings.

Operation proceeds from step 1290 to step 1292. In step 1292 the NPRE 106 updates stored information corresponding to the performance problem being addressed by the network engineer to indicate whether the implemented change, e.g., at a specific base station such as BS A 134, was successful or unsuccessful in resolving the problem. In the case where the network engineer retains a change, it is deemed a successful change to address the problem, and if the network engineer chooses to rollback the change, it is deemed an unsuccessful change with respect to the problem the network engineer was trying to address, as indicated by the network engineer's query for base stations or cells with a particular problem. The stored information relating to a problem, network change made to address the problem, and whether or not the change was successful is available for use in training or updating the corrective action prediction model.

Updating of the corrective action prediction model is optional but performed in some embodiments on a periodic basis using the information stored in step 1292 as training data. In other embodiments the updating/retraining of the corrective action prediction model is triggered by chatbot 104, e.g., after an attempt to correct a problem has been determined to be successful or unsuccessful. In the FIG. 7G example, in step 1294, the chatbot 104 requests a corrective action prediction model training operation using the stored information corresponding to the performance problem which indicates whether the network change was successful or unsuccessful in resolving the performance problem. Step 1294 includes step 1296. In step 1296 the chatbot 104 generates and sends a request 1298 to the NPRE 106, said request 1298 requesting that the corrective action prediction model be trained, e.g., using the stored information corresponding to the network engineer addressed performance problem. Thus, in step 1296 the chatbot 104 generates a request 1298 for corrective action prediction model retraining 1298 and sends it to the NPRE 106. In step 1300 the NPRE 106 receives the request for corrective action prediction model retraining, and then in step 1302 performs the requested retraining, e.g., based on the problem/action/result information stored in step 1292. In this way, information, about a known network performance problem, which has been addressed by the network engineer via a particular corrective action, which produced a known result, success or failure, is used to update, e.g., retrain, the corrective action prediction model. This results in an improvement in future predictions and decreases the chance that failed corrective actions will be recommended by the corrective action prediction module in response to similar problems in the future, while increasing the chance that successful corrective actions will be recommended in response to similar problems encountered in the future.

It should be appreciated that the results of network engineer addressed problems, as well as customer reported problems, are used to update the same corrective action prediction model. Thus, regardless of why or who initiated the process of implementing a corrective action in response to a network problem, the results of the corrective action, once known, can be, and sometimes are, used to update the corrective action prediction module and thus future predictions.

With the corrective action prediction model having been updated in step 1302, operation proceeds to step 1304, in which a retraining complete message 1306 is generated by the NPRE 106 and sent to the chatbot 104 to notify the chatbot 104 that the requested corrective action prediction model training operation has been completed. In step 1308 the chatbot 104 receives the retraining complete message 1306.

While step 1308 represents the completion of a network engineer addressing a particular problem of interest in network performance, the chatbot 104 remains active, ready and available to assist with and respond to additional queries from a network engineer relating to network performance related problems or issues.

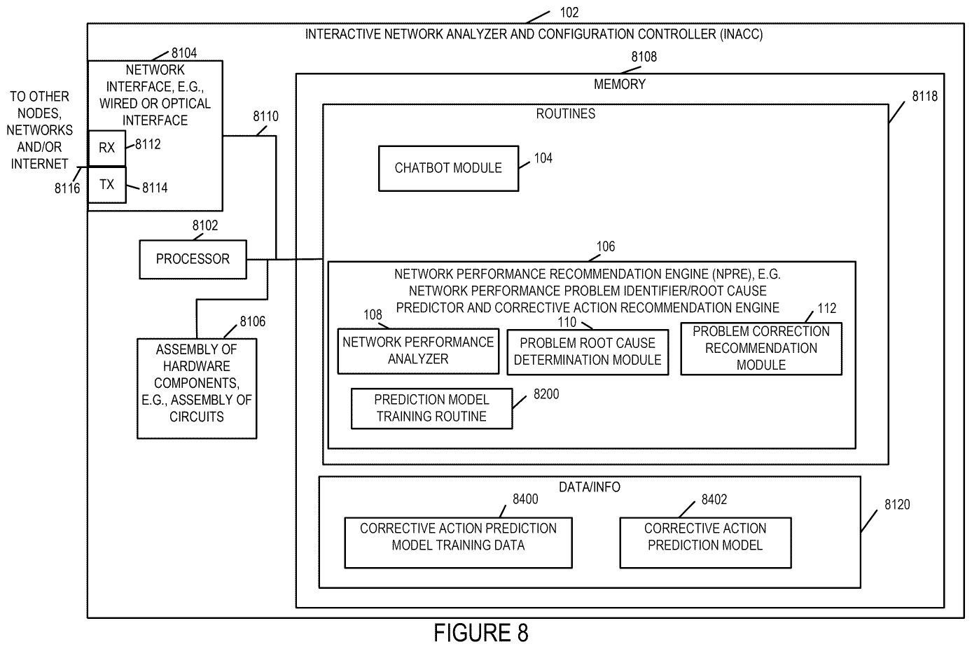

FIG. 8 illustrates an exemplary interactive network and configuration controller (INACC) 102, which can be used as the INACC 102 of the system 100 shown in FIG. 1, and which can be used to support radio access network problem reporting, auto troubleshooting, problem servicing and/or remediation through the use of artificial intelligence. The INACC 102 can also be used to support field operations teams used for radio troubleshooting and/or can support retrieving network information and/or configuration information for routine maintenance work.

The INACC 102 includes a network interface 8104, e.g., a wired or optical interface, which includes a receiver (RX) module 8112, a transmitter (TX) module 8114, and a connector 8116. The INACC 102 is coupled to other nodes, e.g., network nodes, OSS nodes, base stations, UEs, core network nodes, a messaging repository, a database, etc., networks, and/or the Internet via network interface 8104. The INACC 102 sends signals, e.g., signals communicating messages and/or data/information, e.g., chatbot communications, control messages, and data/information, via transmitter 8114 and connector 8116 to other devices. The INACC 102 receives signals, e.g., signals communicating messages and/or data/information, e.g., chatbot communications, control messages, and data/information, via connector 8116 and receiver 8112, from other devices. The network interface 8104 is also coupled to bus 8110 which connects the components of the INACC 102 together, allowing them to communicate with each other and/or with devices external to the INACC 102 via the network interface 8104.

The INACC 102 includes a memory 8108, processor 8102 and assembly of hardware components 8106, which are coupled to the memory 8108 via the bus 8110. Memory 8108 includes routines 8118 and data/information 8120. Routines 8118 includes chatbot module 104 and network performance recommendation engine (NPRE) 106, e.g., a network performance problem identifier/root cause predictor and corrective action recommendation engine. The processor 8102 controls the operation of the INACC 102 under the control of one or more routines in the memory 1108. The routines are stored in the routine storage portion 8118 of memory 1108, while data and other information which can be used by the routines and/or in performing model training are stored in the data/information storage portion 8120 of memory 8108. Memory 8108 includes processor executable instructions, which when executed by the processor 8102 cause the processor 8102 to provide a chatbot 104 and/or network performance recommendation engine (NPRE) 106, which operate in accordance with the invention. The NPRE 106 is capable of: identifying network performance problems, determining the root cause of a problem and providing a problem correction recommendation. To perform these functions, the NPRE 106 includes a network performance analyzer 108, which analyzes network performance related information to identify problems, a problem root cause determination module 110 to determine a root cause of a problem, and a problem correction recommendation module 112. The problem correction recommendation module 112 uses a corrective action prediction model to predict one or more corrective actions which are likely to resolve an identified or reported problem with the predicted corrective action being recommended to the chatbot and/or network engineer as something that should be implemented to resolve a reported or identified problem. The network performance analyzer 108, in addition to identifying problems can be, and sometimes is, used to compare network performance before a corrective action is taken to network performance after a network action has been taken to determine whether the corrective action successfully resolved a reported or identified problem. The NPRE 106 can receive and process problem information and network performance information to make the determinations made by modules 108, 110 and/or 112.

In addition to analyzing network performance, performing root cause determinations and generating corrective action recommendations the NPRE 106 can, under control of the prediction module training routine 8200 retrain and/or update the corrective action prediction model 8402 stored in memory portion 8120, based on updates to the corrective action prediction module training data 8400. The retraining can be implemented on a routine periodic basis or upon the request of the chatbot 104. The corrective action prediction module training data 8400 is updated to reflect user reported or network engineer addressed problems and whether a corrective action taken was successful at correcting the problem or unsuccessful. As the corrective action prediction model 8402 is retrained using additional information added to the training data 8400, the corrective action predictions and thus recommendations provided in response to new problems will improve.

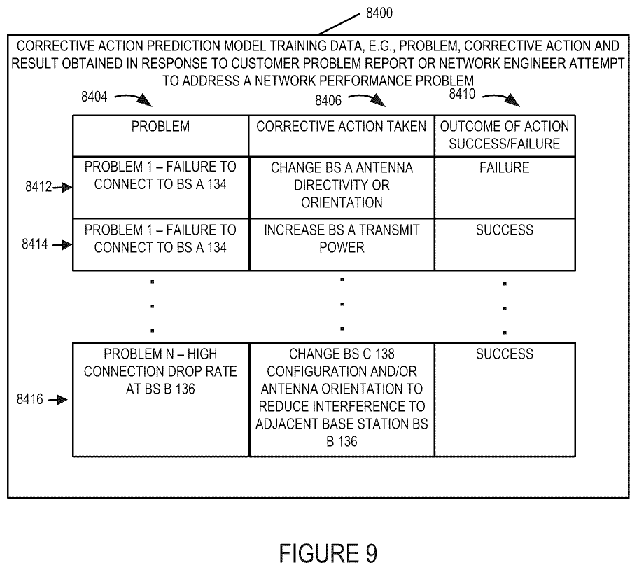

FIG. 9 shows an exemplary set 8400 of corrective action prediction model training data that reflect the results of trying to correct N problems. The information stored in the training data 8400 is shown in table format with each column corresponding to a different type of information and each row corresponding to a different problem and correction attempt. The first column 8404 includes problem information and indicates information about the type of problem addressed but, in many cases, will include additional problem details such as the time, location and severity of the problem addressed, in addition to the type of problem. Cell and base station information indicating which base station or cell suffered the problem is also normally included as part of the problem information stored in the first column 8404. The second column 8406 indicates the corrective network action that was taken to correct the problem, and the third column 8410 indicates whether the corrective action succeeded or failed at correcting the corresponding problem in the same row as the problem/action information.

The first row 8412 includes information corresponding to a first problem. As indicated in the first column of row 8412 the problem (problem 1) was a failure of a UE to connect to BS A 134. The second column of row 8412 indicates that the corrective action taken in response to this problem was to change antenna directivity or orientation at BS A 134 while the third column indicates that this network change was unsuccessful at correcting problem 1. The second row 8414 includes information corresponding to a second attempt to address problem 1, e.g., an attempt made following the failed attempt to resolve problem 1, for which information is listed in the first row 8412. In second attempt to resolve problem 1, which corresponds to second row 8414, BS A 134 transmit power is increased, as indicated in second column 8406, and this resolves problem as indicated by the success indication included in the second row of third column 8410. The training data 8400 can include information on attempts to solve many different problems, e.g., N problems, with the amount of information increasing as new problems are addressed. The last row 8416 includes information corresponding to problem N, which was a high connection drop rate at BS B 136. As indicated by the word success in the third column 8410 of row 8416, problem N was successful resolved by changing a BS C 138 configuration setting and/or antenna orientation to reduce interference caused to adjacent base station BS B 136, as indicated in second column 8406 of row 8416. Accordingly, it should be appreciated that a corrective action that is made or suggested may be at a base station different from the base station where the problem is actually encountered.

As the information in the training set 8400 increases and the corrective action prediction module 8402, used to make corrective action predictions is retrained/updated, the corrective action recommendations provided in response to problems will improve.

While a routine 104 and/or 106 is used to configure the processor 8102 or a portion of the processor 8102 to provide the function to which the module or routine corresponds, in other embodiments a hardware assembly is provided in the assembly of components 8106 to provide the function, which would otherwise be implemented using software, fully in hardware. Accordingly in some embodiments the INACC 102 includes an assembly of hardware components 8106 which includes a hardware implemented chatbot 104 and a hardware implemented network performance recommendation engine NPRE 106.

### NUMBERED LIST OF EXEMPLARY METHOD EMBODIMENTS

Method Embodiment 1. A method of managing a communications system, the method comprising: operating a chatbot (104) to receive (616) a report (615) of a network performance problem from a user (e.g., the user is a customer of a network service provider) of a user equipment device (140); operating the chatbot (104) to collect (617 and/or 687) problem information from the user; operating the chatbot (104) to send (860) a request for problem analysis (862) to a network performance recommendation engine (NPRE) (106); operating the chatbot (104) to receive (892) a response (890) to the request for problem analysis (862), said response including at least a first recommended network change; and operating the chatbot (104) to implement (893) the first recommended network change.

Method Embodiment 1A. The method of Method Embodiment 1, wherein said chatbot (104) and said NPRE (106) are included as components within an interactive network analyzer and configuration controller (INACC) (102).

Method Embodiment 1A1. The method of Method Embodiment 1, wherein said chatbot (104) and said NPRE (106) are located in separate devices.

Method Embodiment 1A2. The method of Method Embodiment 1, wherein said NPRE (106) performs network performance problem identification, network problem analysis, root cause problem predictions, and generates corrective action recommendations.

Method Embodiment 1AA. The method of Method Embodiment 1, wherein the chatbot (104) automatically implements the first recommended network change.

Method Embodiment 1AB. The method of Method Embodiment 1, further comprising: operating the chatbot to provide (8921) a network engineer (NE) information on the reported problem and suggested network changes; and operating the chatbot to receive (8927) a command from the network engineer to implement the first recommended network change; and wherein operating the chatbot to implement (893) the first recommended network change is performed in response to the received command (8926) from the network engineer.

Method Embodiment 1A3. The method of Method Embodiment 1, wherein the first recommended network change is a base station configuration change corresponding to a base station providing coverage at the location where the problem was encountered.

Method Embodiment 1B. The method of Method Embodiment 1, wherein the first recommended network change is a base station transmission power change corresponding to a base station providing coverage at the location where the problem was encountered.

Method Embodiment 1C. The method of Method Embodiment 1, wherein the first recommended network change is a base station antenna orientation change (e.g., antenna rotation and/or tilt) corresponding to a base station providing coverage at the location where the problem was encountered.

Method Embodiment 1D. The method of Method Embodiment 1, wherein the first recommended network change is a base station antenna array change corresponding to a base station providing coverage at the location where the problem was encountered.

Method Embodiment 1E. The method of Method Embodiment 1D, wherein the base station antenna array change includes one, more than one, or all of: a change in phase corresponding to an antenna element of said base station array or a change in a gain setting corresponding to the antenna element of said base station array.

Method Embodiment 1F. The method of Method Embodiment 1D, wherein the base station antenna array change includes a change in gain or phase corresponding to multiple antenna array elements of said base station antenna array.

Method Embodiment 2. The method of Method Embodiment 1, further comprising: operating the chatbot (104) to determine (924) whether the problem was resolved by the implemented first recommended network change.

Method Embodiment 3. The method of Method Embodiment 2, further comprising: updating (974) stored information corresponding to the reported problem to indicate whether the implemented first recommended network change was successful or unsuccessful in resolving the reported network performance problem.

Method Embodiment 4. The method of Method Embodiment 3, further comprising: performing (9844) (e.g. at the NPRE (106)) a corrective action prediction model training operation using the stored information corresponding to the reported problem which indicates whether the implemented first recommended network change was successful or unsuccessful.

Method Embodiment 4A. The method of Method Embodiment 4, wherein the corrective action prediction model training operation is a model retraining or module update operation used to retrain or update a corrective action prediction model which was used to recommend the first recommended network change.

Method Embodiment 5 is supported by a loop back to step (860) with the loop back resulting in a second request and second response where the second response will include a second recommendation different from the first, e.g., because the system now knows the first recommend change was unsuccessful at resolving the problem (and the NPRE (106) knows this by virtue of receiving a second request relating to the previously reported and addressed problem) with, in some but not necessarily all cases the prediction model, u sed to make the prediction having been updated/retrained based on this information.

Method Embodiment 5. The method of Method Embodiment 4, further comprising: operating the chatbot (104) to send (second iteration of 860) a second request for problem analysis (862) (e.g., where the second request for problem analysis includes problem information, problem location information, user ID, UE ID, User ID configuration information, service BS and/or relevant test results from transmission to/from UE suffering problem) to the network performance recommendation engine (NPRE) (106) (e.g. where the second request includes the same information as the first request but will result in a different network change recommendation due to updating of the corrective action prediction model so it will produce a different recommendation rather than the previously failed recommendation or where the second recommendation request includes the same information as the information in the first request (e.g., problem information, problem location information, user ID, UE ID, User ID configuration information, service BS and/or relevant test results from transmission to/from UE suffering problem) plus an unsuccessful network change action which is not to be recommended thereby providing information to make sure the NPRE (106) knows not to repeat the previous first failed action in response to the second request).

Method Embodiment 6. The method of Method Embodiment 5, further comprising: operating the chatbot (104) to receive (second iteration of 892) a second response (second iteration of 890) to the second request for problem analysis (second iteration 862), said second response including a recommended network change which is different from the first recommended network change, said recommended network change being a second recommended network change; and operating the chatbot (104) to implement (second iteration of 893) the second recommended network change.

Method Embodiment 7. The method of Method Embodiment 6, further comprising: operating the chatbot (104) to determine (second iteration of 924) whether the problem was resolved by the implemented second recommended network change.

Method Embodiment 8. The method of Method Embodiment 7, further comprising: updating (second iteration of 974) stored information corresponding to the reported problem to indicate whether the implemented second recommended network change was successful or unsuccessful in resolving the reported network performance problem.

Method Embodiment 9. The method of Method Embodiment 8, further comprising: performing (e.g., at the NPRE 106) a second corrective action prediction model training operation (second iteration of 9844) using the stored information corresponding to the reported problem which indicates whether the implemented second recommended network change was successful or unsuccessful.

Method Embodiment 9A. The method of Method Embodiment 9, wherein the second corrective action prediction model training operation (second iteration of 9844) is a model retraining or module update operation used to retrain or update the corrective action prediction model which was used to recommend the second recommended network change.

Method Embodiment 10 relates to a network engineer, e.g., a network technician in some embodiments, using the chatbot 104 to identify and address network performance issues with the network engineer being able to specify the type of performance problem to be addressed.

Method Embodiment 10. The method of Method Embodiment 1, further comprising: operating the chatbot (104) to receive (1022) a request for information from a user device (1042) corresponding to a network engineer seeking a list of cells with a performance problem of interest indicated by the network engineer (e.g., poor network accessibility, poor average data rate, high or UE drop rate); and operating the chatbot (104) to receive (1106) the list of identified cells with the performance problem of interest from the chatbot in response to the request seeking the list of cells with the performance problem.

Method Embodiment 11. The method of Method Embodiment 10, wherein suggested possible corrective actions are included with the list of identified cells.

Method Embodiment 12. The method of Method Embodiment 11, further comprising: operating the chatbot (104) to receive (1136) an instruction from the network engineer to implement a corrective action specified by the network engineer, said corrective action being one of the suggested possible corrective actions; and operating the chatbot (104) to implement (1137) the corrective action specified by the network engineer.

Method Embodiment 13. The method of Method Embodiment 12, further comprising: operating the chatbot (104) to request (1224) evaluation of the corrective action (e.g., ask NPRE 106 to determine if the change to the network as a result of corrective action resulted in resolution of the performance issue/problem identified by the network engineer or otherwise improved network performance); and operating the chatbot (104) to receive (1236) information on the effect of the corrective action on network performance.

Method Embodiment 14. The method of Method Embodiment 13, further comprising: operating the chatbot (104) to report (1237) to the network engineer on the effect of the corrective action on the network performance.

Method Embodiment 15. The method of Method Embodiment 14, further comprising: operating the chatbot (104) to receive (1253) an instruction from the network engineer indicating whether the corrective action should be maintained or rolled back; and operating the chatbot (104) to maintain (1256) or rollback (1264) the corrective action in accordance with the instruction received from the network engineer.

Method Embodiment 16. The method of Method Embodiment 15, further comprising: performing (1302) (e.g., at the NPRE 106) a corrective action prediction model training operation to update the corrective action prediction model based on whether the corrective network action was successful at resolving the performance problem (e.g., as indicated by the network engineer instructing the change to be maintained) or was unsuccessful at resolving the performance problem (e.g., as indicated by the network engineer indicating that the corrective network action should be rolled back).

### NUMBERED LIST OF EXEMPLARY APPARATUS EMBODIMENTS

Apparatus Embodiment 1. An interactive network analyzer and configuration controller (INACC) (102) for managing a communications system, the INACC (102) comprising: a network interface (8104); memory (8108) including processor executable instructions for implementing a chatbot (104) and processor executable instructions for implementing a network performance recommendation engine (NPRE) (106); and a processor (8102) configured to implement the processor executable instructions stored in memory (8108) to provide a chatbot (104), which can interact with a user device (e.g., UE 140 or (UE 142)) and other network components via the network interface and to provide the network performance engine (106), which can provide correction recommendations, the processor (8102) being configured to: operate the chatbot (104) to receive (616) a report (615) of a network performance problem from a user (e.g., the user is a customer of a network service provider) of a user equipment device (140); operate the chatbot (104) to collect (617 and/or 687) problem information from the user; operate the chatbot (104) to send (860) a request for problem analysis (862) to a network performance recommendation engine (NPRE) (106); operate the chatbot (104) to receive (892) a response (890) to the request for problem analysis (862), said response including at least a first recommended network change; and operate the chatbot (104) to implement (893) the first recommended network change.

Apparatus Embodiment 1A2. The INACC (102) of Apparatus Embodiment 1, wherein said NPRE (106) performs network performance problem identification, network problem analysis, root cause problem predictions, and generates corrective action recommendations.

Apparatus Embodiment 1AA. The INACC (102) of Apparatus Embodiment 1, wherein the chatbot (104) automatically implements the first recommended network change.

Apparatus Embodiment 1AB. The INACC (102) of Apparatus Embodiment 1, wherein the processor (8102) is further configured to: operate the chatbot to provide (8921) a network engineer (NE) information on the reported problem and suggested network changes; and operate the chatbot to receive (8927) a command from the network engineer to implement the first recommended network change; and wherein operating the chatbot to implement (893) the first recommended network change is performed in response to the received command (8926) from the network engineer.

Apparatus Embodiment 1A3. The INACC (102) of Apparatus Embodiment 1, wherein the first recommended network change is a base station configuration change corresponding to a base station providing coverage at the location where the problem was encountered.

Apparatus Embodiment 1B. The INACC (102) of Apparatus Embodiment 1, wherein the first recommended network change is a base station transmission power change corresponding to a base station providing coverage at the location where the problem was encountered.

Apparatus Embodiment 1C. The INACC (102) of Apparatus Embodiment 1, wherein the first recommended network change is a base station antenna orientation change (e.g., antenna rotation and/or tilt) corresponding to a base station providing coverage at the location where the problem was encountered.

Apparatus Embodiment 1D. The INACC (102) of Apparatus Embodiment 1, wherein the first recommended network change is a base station antenna array change corresponding to a base station providing coverage at the location where the problem was encountered.

Apparatus Embodiment 1E. The INACC (102) of Apparatus Embodiment 1D, wherein the base station antenna array change includes one, more than one, or all of: a change in phase corresponding to an antenna element of said base station array or a change in a gain setting corresponding to the antenna element of said base station array.

Apparatus Embodiment 1F. The INACC (102) of Apparatus Embodiment 1D, wherein the base station antenna array change includes a change in gain or phase corresponding to multiple antenna array elements of said base station antenna array.

Apparatus Embodiment 2. The INACC (102) of Apparatus Embodiment 1, wherein the processor (8102) is further configured to operate the chatbot (104) to: determine (924) whether the problem was resolved by the implemented first recommended network change.

Apparatus Embodiment 3. The INACC (102) of Apparatus Embodiment 2, wherein the processor (8102) is further configured to: update information (8400) stored in memory (8108) corresponding to the reported problem to indicate whether the implemented first recommended network change was successful or unsuccessful in resolving the reported network performance problem.

Apparatus Embodiment 4. The INACC (102) of Apparatus Embodiment 3, wherein the processor (8102) is further configured to control the NPRE (106) to: perform a corrective action prediction model training operation using the stored information corresponding to the reported problem which indicates whether the implemented first recommended network change was successful or unsuccessful.

Apparatus Embodiment 4A. The INACC (102) of Apparatus Embodiment 4, wherein the corrective action prediction model training operation is a model retraining or module update operation used to retrain or update a corrective action prediction model which was used to recommend the first recommended network change.

Apparatus Embodiment 5. The INACC (102) of Apparatus Embodiment 4, wherein the processor (8102) is further configured to control the chatbot (104) to: send (second iteration of 860) a second request for problem analysis (862) (e.g., where the second request for problem analysis includes problem information, problem location information, user ID, UE ID, User ID configuration information, service BS and/or relevant test results from transmission to/from UE suffering problem) to the network performance recommendation engine (NPRE) (106) (e.g. where the second request includes the same information as the first request but will result in a different network change recommendation due to updating of the corrective action prediction model so it will produce a different recommendation rather than the previously failed recommendation or where the second recommendation request includes the same information as the information in the first request (e.g., problem information, problem location information, user ID, UE ID, User ID configuration information, service BS and/or relevant test results from transmission to/from UE suffering problem) plus an unsuccessful network change action which is not to be recommended thereby providing information to make sure the NPRE (106) knows not to repeat the previous first failed action in response to the second request).

Apparatus Embodiment 6. The INACC (102) of Apparatus Embodiment 5, wherein the processor (8102) is further configured to control the chatbot (104) to: receive (second iteration of 892) a second response (second iteration of 890) to the second request for problem analysis (second iteration 862), said second response including a recommended network change which is different from the first recommended network change, said recommended network change being a second recommended network change; and implement (second iteration of 893) the second recommended network change.

Apparatus Embodiment 7. The INACC (102) of Apparatus Embodiment 6, wherein the processor (8102) is further configured to control the chatbot (104) to: determine (second iteration of 924) whether the problem was resolved by the implemented second recommended network change.

Apparatus Embodiment 8. The INACC (102) of Apparatus Embodiment 7, wherein the processor (8102) is further configured to: update (second iteration of 974) stored information (8400) in memory (8108) corresponding to the reported problem to indicate whether the implemented second recommended network change was successful or unsuccessful in resolving the reported network performance problem.

Apparatus Embodiment 9. The INACC (102) of Apparatus Embodiment 8, wherein the processor (8102) is further configured to control the NPRE (106) to perform a second corrective action prediction model training operation (second iteration of 9844) using the stored information (8400) corresponding to the reported problem which indicates whether the implemented second recommended network change was successful or unsuccessful.

Apparatus Embodiment 9A. The INACC (102) of Apparatus Embodiment 9, wherein the second corrective action prediction model training operation (second iteration of 9844) is a model retraining or module update operation used to retrain or update the corrective action prediction model which was used to recommend the second recommended network change.

Apparatus Embodiment 10. The INACC (102) of Apparatus Embodiment 1, wherein the processor (8102) is further configured to control the chatbot (104) to: receive (1022) a request for information from a user device (1042) corresponding to a network engineer seeking a list of cells with a performance problem of interest indicated by the network engineer (e.g., poor network accessibility, poor average data rate, high or UE drop rate); and receive (1106) the list of identified cells with the performance problem of interest from the chatbot in response to the request seeking the list of cells with the performance problem.

Apparatus Embodiment 11. The INACC (102) of Apparatus Embodiment 10, wherein suggested possible corrective actions are included with the list of identified cells.

Apparatus Embodiment 12. The INACC (102) of Apparatus Embodiment 11, wherein the processor (8102) is further configured to control the chatbot (104) to: receive (1136) an instruction from the network engineer to implement a corrective action specified by the network engineer, said corrective action being one of the suggested possible corrective actions; and implement (1137) the corrective action specified by the network engineer.

Apparatus Embodiment 13. The INACC (102) of Apparatus Embodiment 12, wherein the processor (8102) is further configured to operate the chatbot (104) to: request (1224) evaluation of the corrective action (e.g., ask NPRE 106 to determine if the change to the network as a result of corrective action resulted in resolution of the performance issue/problem identified by the network engineer or otherwise improved network performance); and receive (1236) information on the effect of the corrective action on network performance.

Apparatus Embodiment 14. The INACC (102) of Apparatus Embodiment 13, wherein the processor (8102) is further configured to operate the chatbot (104) to: report (1237) to the network engineer on the effect of the corrective action on the network performance.

Apparatus Embodiment 15. The INACC (102) of Apparatus Embodiment 14, wherein the processor (8102) is further configured to operate the chatbot (104) to: receive (1253) an instruction from the network engineer indicating whether the corrective action should be maintained or rolled back; and maintain (1256) or rollback (1264) the corrective action in accordance with the instruction received from the network engineer.

Apparatus Embodiment 16. The INACC (102) of Apparatus Embodiment 15, wherein the processor (8102) is further configured to operate the NPRE (106) to: perform (1302) a corrective action prediction model training operation to update the corrective action prediction model based on whether the corrective network action was successful at resolving the performance problem (e.g., as indicated by the network engineer instructing the change to be maintained) or was unsuccessful at resolving the performance problem (e.g., as indicated by the network engineer indicating that the corrective network action should be rolled back).

Some aspects and/or features are directed to a non-transitory computer readable medium embodying a set of software instructions, e.g., computer executable instructions, for controlling a computer or other device, e.g., a vehicle or robotic device, to operate in accordance with the above discussed methods.

The techniques of various embodiments may be implemented using software, hardware and/or a combination of software and hardware. Various embodiments are directed to a control apparatus, e.g., controller or control system, which can be implemented using a microprocessor including a CPU, memory and one or more stored instructions for controlling a device or apparatus to implement one or more of the above described steps. Various embodiments are also directed to methods, e.g., a method of controlling a vehicle or drone or remote control station and/or performing one or more of the other operations described in the present application. Various embodiments are also directed to a non-transitory machine, e.g., computer, readable medium, e.g., ROM, RAM, CDs, hard discs, etc., which include machine readable instructions for controlling a machine to implement one or more steps of a method.

As discussed above, various features of the present invention are implemented using modules and/or components. Such modules and/or components may, and in some embodiments are, implemented as software modules and/or software components. In other embodiments the modules and/or components are implemented in hardware. In still other embodiments the modules and/or components are implemented using a combination of software and hardware. In some embodiments the modules and/or components are implemented as individual circuits with each module and/or component being implemented as a circuit for performing the function to which the module and/or component corresponds. A wide variety of embodiments are contemplated including some embodiments where different modules and/or components are implemented differently, e.g., some in hardware, some in software, and some using a combination of hardware and software. It should also be noted that routines and/or subroutines, or some of the steps performed by such routines, may be implemented in dedicated hardware as opposed to software executed on a general purpose processor.

Such embodiments remain within the scope of the present invention. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods. Accordingly, among other things, the present invention is directed to a machine-readable medium including machine executable instructions for causing a machine, e.g., processor and associated hardware, to perform one or more of the steps of the above-described method(s).

The techniques of the present invention may be implemented using software, hardware and/or a combination of software and hardware. The present invention is directed to apparatus, e.g., a vehicle which implements one or more of the steps of the present invention. The present invention is also directed to machine readable medium, e.g., ROM, RAM, CDs, hard discs, etc., which include machine readable instructions for controlling a machine to implement one or more steps in accordance with the present invention.

Numerous additional variations on the methods and apparatus of the various embodiments described above will be apparent to those skilled in the art in view of the above description. Such variations are to be considered within the scope.

What is claimed is:

1. A method of managing a communications system, the method comprising:
operating a chatbot to receive a report of a network performance problem from a user of a user equipment device;
operating the chatbot to collect problem information from the user;
operating the chatbot to send a request for problem analysis to a network performance recommendation engine (NPRE);
operating the chatbot to receive a response to the request for problem analysis, said response including at least a first recommended network change; and
operating the chatbot to implement the first recommended network change.

2. The method of claim 1, further comprising:
operating the chatbot to determine whether the problem was resolved by the implemented first recommended network change.

3. The method of claim 2, further comprising:
updating stored information corresponding to the reported problem to indicate whether the implemented first recommended network change was successful or unsuccessful in resolving the reported network performance problem.

4. The method of claim 3, further comprising:
performing a corrective action prediction model training operation using the stored information corresponding to the reported problem which indicates whether the implemented first recommended network change was successful or unsuccessful.

5. The method of claim 4, further comprising:
operating the chatbot to send a second request for problem analysis to the network performance recommendation engine (NPRE).

6. The method of claim 5, further comprising:
operating the chatbot to receive a second response to the second request for problem analysis, said second response including a recommended network change which is different from the first recommended network change, said recommended network change being a second recommended network change; and
operating the chatbot to implement the second recommended network change.

7. The method of claim 6, further comprising:
operating the chatbot to determine whether the problem was resolved by the implemented second recommended network change.

8. The method of claim 7, further comprising:
updating stored information corresponding to the reported problem to indicate whether the implemented second recommended network change was successful or unsuccessful in resolving the reported network performance problem.

9. The method of claim 8, further comprising:
performing a second corrective action prediction model training operation using the stored information corresponding to the reported problem which indicates whether the implemented second recommended network change was successful or unsuccessful.

10. The method of claim 1, further comprising:
operating the chatbot to receive a request for information from a user device corresponding to a network engineer seeking a list of cells with a performance problem of interest indicated by the network engineer; and
operating the chatbot to receive the list of identified cells with the performance problem of interest from the chatbot in response to the request seeking the list of cells with the performance problem.

11. The method of claim 10, wherein suggested possible corrective actions are included with the list of identified cells.

12. The method of claim 11, further comprising:
operating the chatbot to receive an instruction from the network engineer to implement a corrective action specified by the network engineer, said corrective action being one of the suggested possible corrective actions; and
operating the chatbot to implement the corrective action specified by the network engineer.

13. The method of claim 12, further comprising:
operating the chatbot to request evaluation of the corrective action; and
operating the chatbot to receive information on the effect of the corrective action on network performance.

14. The method of claim 13, further comprising:
operating the chatbot to report to the network engineer on the effect of the corrective action on the network performance.

15. The method of claim 14, further comprising:
operating the chatbot to receive an instruction from the network engineer indicating whether the corrective action should be maintained or rolled back; and
operating the chatbot to maintain or rollback the corrective action in accordance with the instruction received from the network engineer.

16. An interactive network analyzer and configuration controller (INACC) for managing a communications system, the INACC comprising:
a network interface;
memory including processor executable instructions for implementing a chatbot and processor executable instructions for implementing a network performance recommendation engine (NPRE); and
a processor configured to implement the processor executable instructions stored in memory to provide a chatbot, which can interact with a user device and other network components via the network interface and to provide the network performance engine, which can provide correction recommendations, the processor being configured to:
operate the chatbot to receive a report of a network performance problem from a user of a user equipment device;
operate the chatbot to collect problem information from the user;
operate the chatbot to send a request for problem analysis to a network performance recommendation engine (NPRE);
operate the chatbot to receive a response to the request for problem analysis, said response including at least a first recommended network change; and
operate the chatbot to implement the first recommended network change.

17. The INACC of claim 16, wherein the processor is further configured to operate the chatbot to:
determine whether the problem was resolved by the implemented first recommended network change; and
update information stored in memory corresponding to the reported problem to indicate whether the implemented first recommended network change was successful or unsuccessful in resolving the reported network performance problem.

18. The INACC of claim 17, wherein the processor is further configured to control the NPRE to:
perform a corrective action prediction model training operation using the stored information corresponding to the reported problem which indicates whether the implemented first recommended network change was successful or unsuccessful.

19. The INACC of claim 16, wherein the processor is further configured to control the chatbot to:
receive a request for information from a user device corresponding to a network engineer seeking a list of cells with a performance problem of interest indicated by the network engineer; and
receive the list of identified cells with the performance problem of interest from the chatbot in response to the request seeking the list of cells with the performance problem.

20. The INACC of claim 19, wherein suggested possible corrective actions are included with the list of identified cells; and
wherein the processor is further configured to control the chatbot to:
receive an instruction from the network engineer to implement a corrective action specified by the network engineer, said corrective action being one of the suggested possible corrective actions; and
implement the corrective action specified by the network engineer.
